(19) United States
(12) Patent Application Publication
(10) Pub. No.: US 2026/0311384 A1
(43) Pub. Date: Oct. 8, 2026

(54) AI AGENT ARCHITECTURE FOR AUDIENCE-SPECIFIC MEDIA CONTENT GENERATION

(71) Applicant: GOOGLE LLC, Mountain View, CA (US)

(72) Inventors: Joseph Patrick Timmons, Flagler Beach, FL (US); John Scott Penberthy, Truckee, CA (US); Nicholas Earl Losier, Centennial, CO (US); Jasmine N. Leon, Maryland Heights, MO (US); Zachary Andrej Chomyn, Peterborough (CA)

(21) Appl. No.: 19/636,639

(22) Filed: Apr. 1, 2026

Related U.S. Application Data
(60) Provisional application No. 63/784,700, filed on Apr. 7, 2025.
(60) Provisional application No. 63/807,320, filed on May 16, 2025.

(51) Int. Cl. G06T 11/00; G06N 5/04

(52) U.S. Cl. CPC G06T 11/00; G06N 5/04

(57) ABSTRACT

A method of automatically generating media content associated with a product and an audience includes generating a creative brief using a set of trained artificial intelligence (AI) agents. Generating the creative brief includes using an audience inference AI agent to infer one or more characteristics of the audience based on at least one audience parameter, using a setting AI agent to generate a setting descriptor based on at least one product parameter and the inferred audience characteristic(s), using a scenario agent to generate a scenario descriptor based on at least one product parameter and the inferred audience characteristic(s), and using a creative brief AI agent to generate the creative brief based on the setting descriptor and the scenario descriptor. The method further includes generating a prompt based on the creative brief, and applying the prompt to a generative AI model to generate the media content.

### CROSS-REFERENCE TO RELATED APPLICATIONS

This claims the benefit of U.S. Provisional Patent Application No. 63/784,700, filed on Apr. 7, 2025, and U.S. Provisional Patent Application No. 63/807,320, filed on May 16, 2025. The disclosure of each of the above-identified patent applications is hereby incorporated by reference herein in its entirety.

### FIELD OF TECHNOLOGY

The present disclosure relates to digital media (e.g., video or image) generation techniques and, more particularly, to techniques for using generative artificial intelligence to generate high-quality (e.g., cinematic quality) media content based on dynamically changing source information (e.g., intended audience data) and/or using feedback/learning techniques.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In some scenarios, it is desirable to create digital media content that is customized based on a particular segment of the population (audience), and possibly also in other ways. In digital advertising, for example, advertisements are typically customized not only to a particular product or service being offered, but also for a particular audience (e.g., a particular age range). To expedite the creation of images or videos for such advertisements, the use of generative artificial intelligence (AI) models has gained traction. However, generative AI models tend to produce low-quality images or video in many respects. For example, images and videos produced by such models typically lack visual consistency, contain inaccuracies in the depicted subject matter (e.g., due to hallucinations), contain content that fails to engage viewers due to generally low quality, fail to comply with brand guidelines (and/or regulations, etc.), and/or are deficient in other respects. As a more specific example, images and videos produced by such models commonly suffer from pose estimation problems, such as by depicting missing limbs or “fused” limbs (e.g., limbs that appear to be fused to an object other than the person).

Various current approaches involve a human-intensive post-production process, or rely on disparate AI tools, leading to inefficiencies and suboptimal results. For example, simply using off-the-shelf models typically results in poor alignment with cinematic aesthetics, requiring numerous iterations or extensive manual intervention to achieve acceptable quality. Processes such as dividing a creative concept into scenes, dividing scenes into shots, generating the starting/ending images for the shots with AI, “tweening” (i.e., filling in the frames between starting and ending frames/images), and synchronizing various elements like audio and visual effects is highly complex, and prone to errors when relying on naive assembly or blind splicing from AI models. As a result, the yield of usable content can be extremely low (e.g., with only one good image or video out of well over one hundred candidate images or videos).

### SUMMARY

Techniques of the present disclosure can remedy at least some of the above-noted deficiencies by using an orchestrated set of AI agents, trained to perform specific interrelated tasks, to generate media content (e.g., a video, or start/stop images/frames to be used with tweening techniques, etc.) for a given set of product and audience parameters. One or more of the AI agents can infer certain facts (e.g., audience characteristics such as interests, typical income levels, etc.) from the audience parameters, while other AI agents process the product and/or audience parameters (and/or the inferred outputs of one or more other AI agents) to generate descriptors for particular aspects of media content, such as setting, scenario, character description, techniques (e.g., shot composition and/or other film/cinematic techniques to apply), and/or other aspects. An additional AI agent processes the descriptors, and possibly the product/audience parameters and/or the AI agent inferences, to generate a creative brief, which is then used to create a prompt for a generative AI model that generates the media content. The techniques may also use AI agents to generate audio (e.g., a voiceover and/or music) for the media content based on the parameters and/or inferred outputs.

By orchestrating the use of multiple, specialized AI agents, the disclosed techniques can better ensure that the generated media content maintains a high standard in various key aspects (e.g., depicting a setting relevant to the audience location, depicting a scenario relevant to the audience interests, maintaining high cinematic quality, etc.). Moreover, the staged approach of using certain AI agents for inference, certain AI agents for generating/describing certain media content elements (setting, scenario, etc.), and another AI agent for generating the creative brief can maintain a tighter control on the consistency, accuracy, and/or continuity of each such aspect (e.g., as compared to only prompting a single large language model (LLM) to generate a text description of a video or image(s) for a particular product and audience). As a result, the disclosed techniques can—in addition to being highly scalable and adaptable due to the extent of automation—create media content that has improved objective performance metrics, such as high click-through or conversion rates.

The disclosed techniques can also, in some implementations, automatically select one or more assets (e.g., advertiser-supplied images, brand logos, etc.) based on product parameters, and the AI agent that generates the creative brief (and/or other AI agents) may use the selected asset(s) to generate the creative brief. Such techniques can help to ensure that the final media content is properly aligned with images, colors, etc. (e.g., logos and brand colors), associated with the provider of the offered product.

The disclosed techniques can also, in some implementations, facilitate compliance with guidelines (e.g., brand safety guidelines) and/or regulations, etc. In various implementations, greater compliance may be achieved by providing compliance data (e.g., one or more electronic documents) as inputs/context to one or more of the AI agents, by training one or more of the above-mentioned AI agents on the compliance data, and/or by using an additional AI agent (trained on the compliance data) to analyze the compliance of the media content that was generated based on the prompt containing the creative brief.

In some aspects and/or implementations, the disclosed techniques help ensure the creation of high-quality media content (image and/or video content) using an AI-driven “actor-critic” model, where a quality assessment engine handles the role of “critic” by using a multimodal generative AI model to generate feedback based on an assessment of media content generated by an “actor” agent (e.g., an agent that generates media content based on the creative brief discussed above), where the feedback (e.g., text descriptors and/or bounding boxes, etc.) indicates characteristic(s) of the media content that impair quality (e.g., cinematic quality) of the media content. For example, the feedback may indicate specific ways in which the media content poorly depicts lighting, posing, facial expressions, framing issues, complex scene elements, and so on. Using principles akin to reinforcement learning, the disclosed techniques may revise the prompt to the actor agent based on the feedback, instructing the actor agent to generate new/revised media content that remedies the quality deficiencies of the original media content. Such a process may repeat/iterate any suitable number of times (e.g., until the quality assessment engine determines that suitable quality is achieved, or until a maximum latency or maximum number of iterations is reached, etc.). Using a quality assessment engine as disclosed herein has been demonstrated to provide significant improvements in yield and quality as compared to baseline AI models.

In some implementations, the prompt to the multimodal generative AI model of the quality assessment engine includes one or more keywords (e.g., search engine optimization keywords) that activate learned states of the multimodal generative AI model that are associated with high-quality media content. Advantageously, this approach can be more effective than rule-based methods or reliance on techniques such as pose estimation, both of which often misinterpret or accept flawed imagery.

The disclosed techniques may also incorporate online learning, by using feedback from the quality assessment engine to identify concise learnings for improving media content quality, and adding these learnings over time to a persistent, long-term context database. For example, a generative AI model may generate the concise learnings by analyzing feedback and corresponding prompt revisions from earlier iterations and/or earlier assessments of different media content items. These accumulated learnings can generally be used to enhance prompts applied to the actor agent, thereby enabling the actor agent to benefit from past lessons learned. This in turn can improve processing efficiency and reduce latency, as leveraging the learnings can enable the actor agent to arrive at a high-quality video or image with fewer actor-critic loops/iterations. Moreover, and counter-intuitively, using these concise learnings instead of a more detailed history (e.g., detailed feedback information and corresponding revisions from the iterations associated with other media content items) can prevent confusion and performance degradation for the actor agent.

Other advantages will also become apparent to one of ordinary skill in the art upon reading this disclosure and viewing the corresponding drawings.

### BRIEF DESCRIPTION OF THE DRAWINGS

FIG. 1 is a block diagram of an example system in which media generation techniques of the present disclosure can be implemented.

FIG. 2 depicts an example architecture for generating, assessing, and/or revising media content, which may be implemented by the computing system of FIG. 1.

FIG. 3 depicts an example AI agent architecture that may be implemented by an AI agent orchestrator.

FIG. 4 depicts another example AI agent architecture that may be implemented by an AI agent orchestrator for a visual component of a video.

FIG. 5 depicts an example AI agent architecture that may be implemented by an AI agent orchestrator for an audio component of a video.

FIG. 6 depicts an example process that may be implemented by the quality assessment engine of FIG. 1, in conjunction with an actor agent of the media generator of FIG. 1.

FIG. 7 depicts an example video generation process that may be used in conjunction with techniques of the present disclosure.

FIG. 8 is a flow diagram of an example method of automatically generating media content associated with a product and an audience.

FIG. 9 is a flow diagram of an example method of improving media content quality.

### DETAILED DESCRIPTION OF THE DRAWINGS

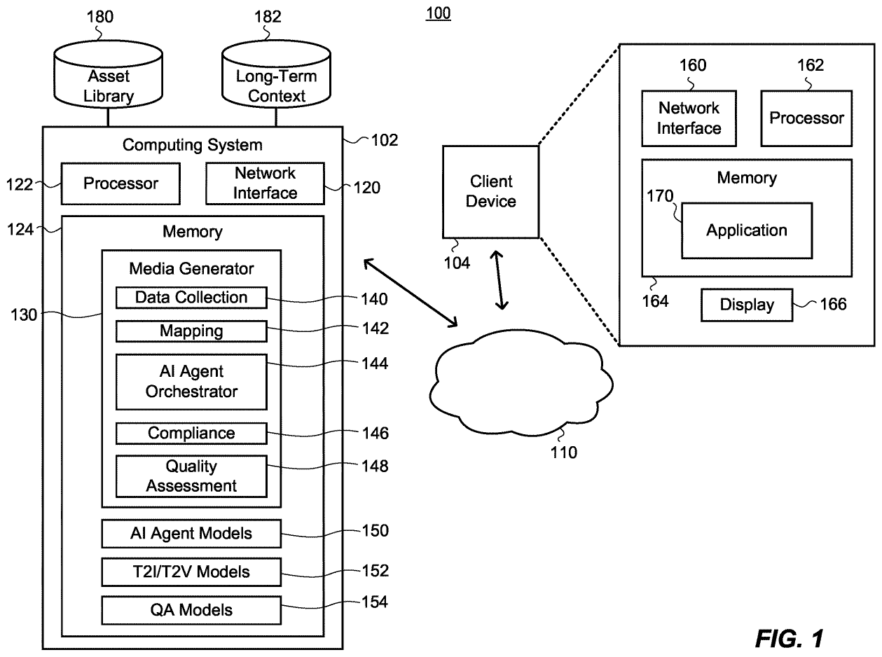

FIG. 1 is a block diagram of an example system 100 in which media content generation techniques of the present disclosure can be implemented. The example system 100 includes a computing system 102, a client device 104, and a network 110. The computing system 102 may be remote from the client device 104, and is communicatively coupled to the client device 104 via the network 110. In some implementations, the system 100 does not include a client device 104 separate from the computing system 102 (e.g., computing system 102 may additionally be configured to implement the functionality of client device 104 as described herein).

The network 110 may be a single communication network (e.g., the Internet), and in some implementations also includes one or more additional networks. As just one example, the network 110 may include a cellular network, the Internet, and a server-side local area network (LAN). While FIG. 1 shows only a single client device 104, it is understood that the computing system 102 may also be in communication with a number (e.g., hundreds or thousands) of other client devices that are generally similar to the client device 104.

Generally, computing system 102 can perform media content (e.g., video and/or image) generation services for entities such as advertisers. For example, an advertiser or other entity associated with client device 104 may request media content generation services from computing system 102, to obtain video and/or image advertisements for an advertising account or campaign. As discussed further below, an advertiser may use the service to generate different media content for different products and/or different audience segments, and/or may use the service to generate multiple such advertisements for a single product and audience segment (e.g., to leverage a greater diversity of video and/or other advertisements, and/or to assess which advertisements perform best with respect to impression rate, click-through rate, conversion rate, and/or other metrics, etc.). As used herein, the term “product” can refer to a product, a service, a collection of multiple products or services, or a combination of product(s) and/or service(s). Moreover, as used herein, terms such as “audience” or “audience segment” can refer to a particular group of people (e.g., a particular demographic), or to a particular person, generally known (or expected to be, etc.) interested in a particular product.

The client device 104 is generally configured to access one or more user interfaces (e.g., web pages and/or user interfaces of mobile applications or other applications) that enable interaction with the computing system 102. For example, the computing system 102 may be associated with a service provider that broadly provides digital advertising services to advertisers, and the entity associated with client device 104 may have an account with the service provider. A user of client device 104 can then enter, modify, etc. settings of an ad campaign associated with the account (e.g., settings for ad groups, keywords, budgets, etc.), via a user interface of a website or application hosted or provided by computing system 102. One or more such campaign settings may enable the user to select or use a service that automatically generates product-and audience-specific media content for the advertiser based on certain input parameters that relate to the product and the intended audience (e.g., information entered by the user or automatically retrieved from account storage). In other implementations, the entity associated with computing system 102 more specifically offers a service for product-and audience-specific media content generation, without broadly providing other digital advertising services.

The computing system 102 includes a network interface 120, a processor 122, and memory 124. The network interface 120 includes hardware, firmware, and/or software configured to enable the computing system 102 to exchange electronic data with the client device 104 and possibly other, similar client devices via the network 110. For example, the network interface 120 may include a wired or wireless router and a modem. The processor 122 may be a single processor (e.g., a central processing unit (CPU)), or may include multiple processors (e.g., multiple CPUs, or one or more CPUs and one or more graphics processing units (GPUs)). Computing system 102 may be a single computing device (e.g., server) at a single location, or may include multiple, coordinating computing devices that are either co-located or remotely distributed.

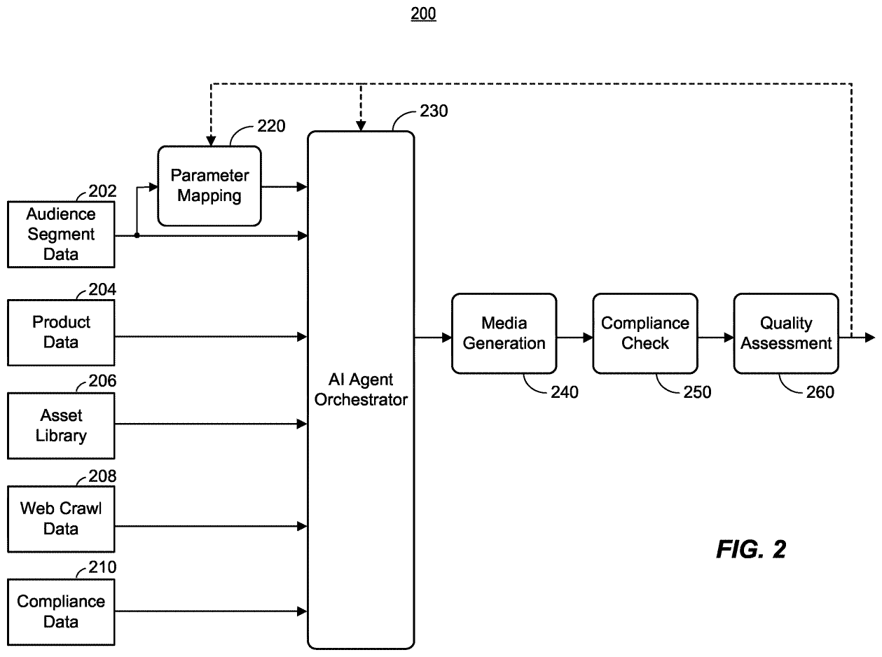

The memory 124 is a computer-readable, non-transitory storage medium, unit, or device, or a collection of such media/units/devices, and may include persistent and/or non-persistent memory components. The memory 124 stores instructions executable by processor 122 to perform various operations, including the instructions of various software applications and the data generated and/or used by such applications. In the example system 100 of FIG. 1, memory 124 stores the instructions of a media generator 130, which includes a data collection module 140, a mapping module 142, an AI agent orchestrator 144, a compliance module 146, and a quality assessment engine 148. The operations of these components, according to various implementations, are discussed in greater detail below with reference to reference to FIGS. 2-9. Generally, however, data collection module 140 is configured to obtain parameter sets (e.g., product and audience parameters) for use as input to the media content generation process, mapping module 142 is configured to map certain parameters to other parameters based on predefined rules or algorithms, AI agent orchestrator 144 is configured to orchestrate a set of trained AI agents to generate media content (e.g., images and/or videos) based on the parameter sets, compliance module 146 is configured to facilitate compliance of the generated media content with one or more sets of compliance guidelines, regulations, etc., and quality assessment engine 148 is configured to assess media content generated by media generator 130. In some implementations, the quality assessment engine 148 also performs compliance assessments, and compliance module 146 is omitted from system 100.

In the depicted implementation, AI agent models 150 (i.e., the trained models used by AI agent orchestrator 144) and text-to-image (T2I) and/or text-to-video (T2V) models 152 (e.g., including models used by media generator 130 to generate one or more images and/or a video based on the creative brief generated by AI agent orchestrator 144) are also stored in memory 124. Also in the depicted implementation, memory 124 stores one or more quality assessment (QA) models 154, which is/are generally used by quality assessment engine 148 to assess media content quality and provide feedback as discussed in further detail below, and/or may be used to monitor performance associated with generated media content. In other implementations, some or all of AI agent models 150, T2I/T2V models 152, and/or QA models 154 is/are stored not in memory 124 but rather in a remote server or other computing device or system. For example, AI agent models 150, T2I/T2V models 152, and/or QA models 154 may be remotely accessed (e.g., as a cloud service) by media generator 130 via network 110.

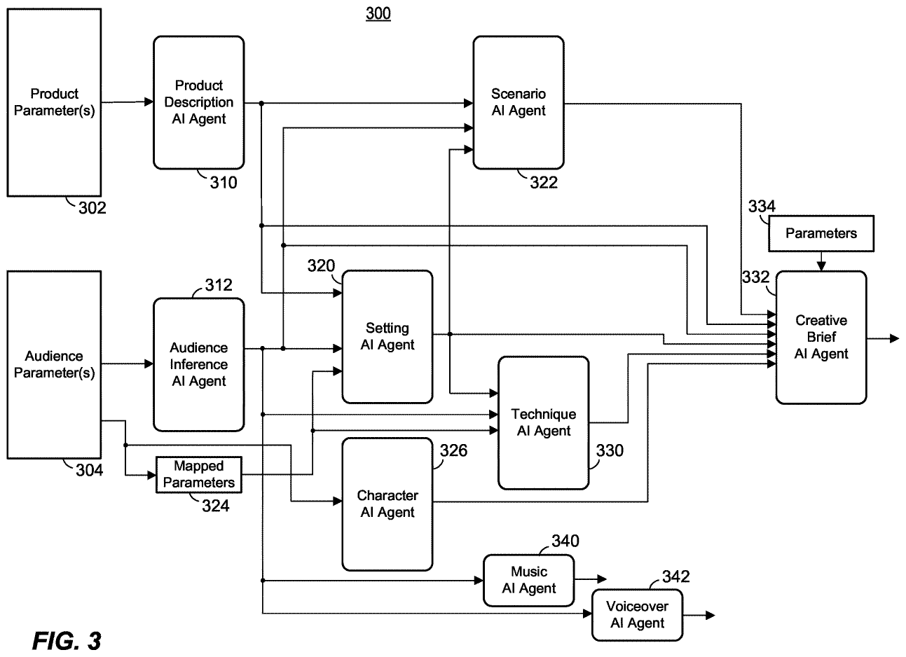

Generally, and as discussed below with reference to specific example implementations, the AI agent models 150 may include one or more types of machine learning models, such as large language models (LLMs), multimodal LLMs (MLLMs), classification models (e.g., neural networks, support vector machines, clustering models, regression models, decision trees, etc.), and so on. Some or all of the AI agent models 150 may be specifically trained (e.g., initially trained or fine-tuned) to perform their tasks as described herein, e.g., using supervised learning techniques. In some implementations, however, one or more of the AI agent models 150 are only generally trained, rather than being trained specifically for the task/functionality described herein. “AI agents” and the “models” employed by those AI agents may at times be referred to interchangeably (e.g., by describing a parameter as being input to an AI agent, or as being input to a model that is used by the AI agent), but it is understood that an “AI agent” can be a model, a collection of models that contribute to the same general function or purpose that is described herein, or a combination one or more models and associated code (and/or libraries, etc.), etc. Moreover, in some cases, a single “AI agent” may comprise multiple AI agents having a more granular functionality. For example, a “product description AI agent” (e.g., AI agent 310 in FIG. 3, discussed below) may use only a single model, or may comprise a first AI agent that uses a first LLM or MLLM to generate a product appearance description and a second AI agent that uses the first LLM or MLLM and/or a second LLM or MLLM to generate a product usage description, etc.

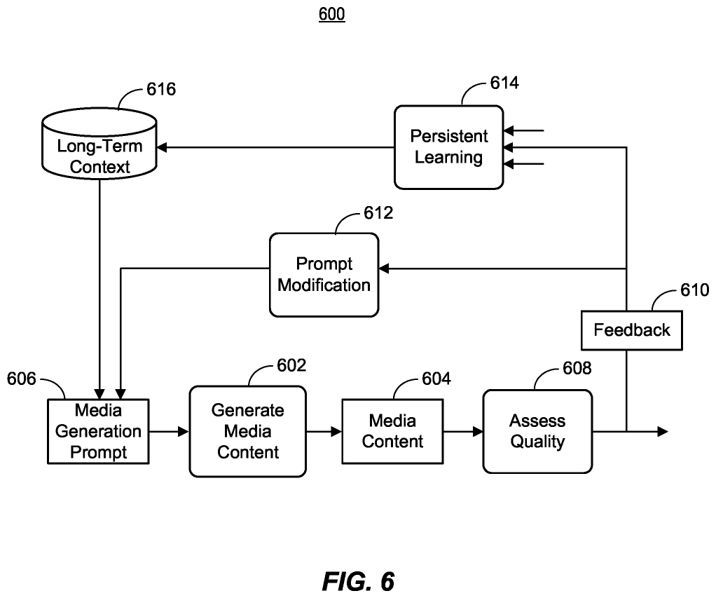

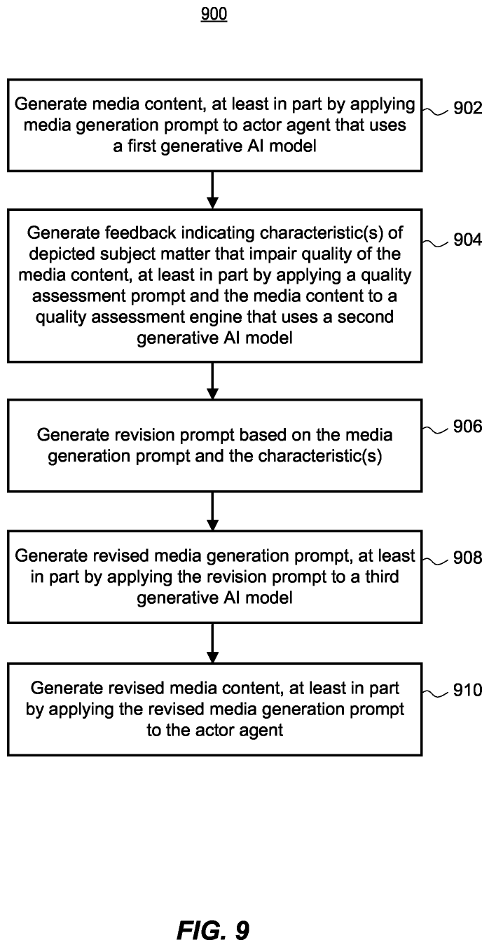

The QA models 154 may include one or more types of machine learning models, such as one or more MLLMs and possibly one or more single-mode LLMs. Some or all of the QA models 154 may be specifically trained (e.g., initially trained or fine-tuned) to perform their tasks as described herein, e.g., using supervised learning techniques. In some implementations, however, one, some, or all of the QA models 154 are only generally trained, rather than being trained specifically for any task/functionality described herein. The use of the QA models 154 is discussed in further detail below, primarily with reference to FIGS. 6 and 9.

The T2I/T2V models 152 may include any suitable type(s) of T2I, T2V, and/or other models, such as latent diffusion models. Generally, while referred to herein as “T2I/T2V” models, models 152 may be any suitable type of video generation model(s) or combination of models. In some implementations, models 152 include a T2I model that generates starting and/or ending images/frames from the creative brief output by AI agent orchestrator 144 (e.g., starting and/or ending frames for each of a series of scenes or shots), and a different model that accomplishes tweening by accepting starting/ending frame pairs as inputs and generating video frames to fill in the gaps between each starting/ending frame pair. The portion of the media generator 130 that uses one or more of models 152 can itself be viewed as an agent (e.g., the actor agent discussed below in connection with FIG. 6 or FIG. 9).

Also shown in FIG. 1 are an asset library 180 and a long-term context database 182, each of which is may be stored in persistent memory of memory 124 and/or in one or more other persistent memories (e.g., at respective remote databases/servers). Asset library 180 and long-term context database 182 are discussed further below.

The client device 104 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, client device 104 includes a network interface 160, a processor 162, memory 164, and a display 166. The processor 162 may be a single processor, or may include multiple processors.

Memory 164 includes one or more computer-readable, non-transitory storage media, units, or devices, which may include persistent and/or non-persistent memory components. Memory 164 stores instructions that are executable by processor 162 to perform various operations, including the instructions of various software applications and the data generated and/or used by such applications.

In the example system 100 of FIG. 1, memory 164 stores at least an application 170. For example, application 170 may be a web browser application used to access a website hosted by computing system 102, or a dedicated application (e.g., mobile application) downloaded from computing system 102 or otherwise associated with the entity maintaining computing system 102, etc. Generally, application 170 is executed by processor 162 to provide one or more user interfaces via display 166, where the user interface(s) enable a user to provide inputs to media generator 130, such as product parameters (e.g., product names, brand names, etc.) and/or audience parameters (e.g., audience locations, audience ages or age ranges, etc.). The user interface(s) may also enable a user to provide digital assets, such as images, graphics (e.g., brand logos), etc., to the computing system 102 for local storage in asset library 180. As still another example, the user interface(s) may enable a user to view and/or provide feedback on videos and/or images generated by media generator 130.

The display 166 includes hardware, firmware, and/or software configured to enable a user to view visual outputs of the client device 104, and may use any suitable display technology (e.g., LED, OLED, LCD, etc.). In some implementations, the display 166 is incorporated in a touchscreen having both display and manual input capabilities. While not shown in FIG. 1, client device 104 can also include one or more audio output devices or components such as one or more speakers (e.g., for presenting audio that accompanies videos or still images generated by media generator 130).

The network interface 160 includes hardware, firmware, and/or software configured to enable the client device 104 to exchange electronic data with the computing system 102 via the network 110. For example, the network interface 160 may include a cellular communication transceiver, a WiFi transceiver, and/or transceivers for one or more other wired and/or wireless communication technologies.

FIG. 2 depicts an example architecture 200 for generating and assessing media content (e.g., a video or an image), which may be implemented by the computing system 102 of FIG. 1. Sources/inputs to the example architecture 200, which are retrieved or otherwise collected by data collection module 140, include audience segment data 202, product data 204, an asset library 206, web crawl data 208, and compliance data 210. In other implementations, more or fewer sources/inputs may be used (e.g., asset library 206, web crawl data 208, and/or compliance data 210 may be omitted, etc.).

Audience segment data 202 may include one or more parameters indicative of a particular audience, such as a location parameter (e.g., country, state, region, etc.), an age parameter (e.g., an age or age range), and/or other parameter(s) (e.g., gender, occupation or occupation category, etc.). In some implementations, the audience segment data 202 is initially entered by a user of client device 104 via a user interface, such as via a website or other application as discussed above, and then locally stored in memory 124 for later retrieval by data collection module 140.

Product data 204 may include one or more parameters indicative of a particular product, such as a product identifier (e.g., product name), a brand name under which the product is offered, and/or other parameter(s) (e.g., a product category, etc.). As noted above, the term “product” as used herein can refer to a product, a service, a collection of multiple products or services, or a combination of product(s) and/or service(s). In some implementations, the product data 204 is initially entered by a user of client device 104 via a user interface, such as via a website or other application as discussed above, and then locally stored in memory 124 for later retrieval by data collection module 140.

Asset library 206 may include one or more digital assets (e.g., images, graphics, etc.) associated with the product represented by product data 204. For example, asset library 206 may include one or more supplier-approved logo images or graphics, product images (e.g., from different views/perspectives, at different zoom levels, etc.), and so on. In some implementations, the digital assets in the asset library 206 are initially supplied by a user of client device 104 via a user interface, such as via a website or other application as discussed above, and then locally stored in asset library 180 for later retrieval by data collection module 140.

Web crawl data 208 may include data that computing system 102 (or another suitable computing system) scrapes from the Internet on a periodic (e.g., daily, weekly, monthly, etc.) or other suitable basis. The scraped data may include, for example, data indicative of cinematic techniques, advertising techniques, psychological studies, news, and so on. In some implementations, computing system 102 applies a time filter such that the data collected in any one crawl/scraping is relatively recent (e.g., from the last 24 hours, or since the last scraping, etc.). Thus, the scraped data may generally be indicative of current events, political happenings or trends, new cinematic trends, the current economic climate in particular locations, and so on. The computing system 102 (or other computing system) may generate and maintain a dynamic document based on the scraped data, e.g., by adding new data (e.g., new data that computing system 102 determines, via a machine learning model, to have at least some threshold relevance to generating advertisements, etc.) and removing old/stale data (e.g., news or trend data that is more than a threshold number of days old, etc.) on a recurring basis. In some implementations, electronic documents (e.g., whitepapers, web pages, etc.) that are identified in a current crawl/scrape as being of relevance by computing system 102 are presented to a user (e.g., the user of client device 104) via a user interface, enabling the user to selectively adopt or not adopt each document for use in media content generation (e.g., as discussed below with respect to various examples).

Compliance data 210 may include one or more compliance electronic documents or text applicable to the product represented by product data 204. For example, compliance data 210 may include brand safety guidelines, industry-specific regulations (e.g., HIPAA or finance regulations), and/or other text indicative of rules, requirements, recommendations, etc., with which an advertisement for the product should or must comply. In some implementations, the compliance data 210 is initially supplied by a user of client device 104 via a user interface, such as via a website or other application as discussed above, and then locally stored in memory 124 for later retrieval by data collection module 140.

A parameter mapping 220 may be performed, by mapping module 142, to map one or more of the audience parameters in audience segment data 202 to one or more other parameters based on predefined rules or algorithms. For example, mapping module 142 may map an age parameter in audience segment data 202 to a tone parameter, where the tone parameter indicates a desired tone for the media content being generated using architecture 200. A more specific example of such a mapping is shown below, in an embodiment where the tone parameter has multiple sub-parameters or dimensions:

### Age Range Tone

18-24 [energetic, trendy]
25-30 [sophisticated]
31-60 [nostalgic, cinematic, authentic]
60+ [cinematic, warm]

In some implementations, the media generator 130 (e.g., mapping module 142 or another module not depicted in FIG. 1) also generates one or more parameters for a given item of media content without any parameter input or mapping. For example, if the media content being generated is a video (or an image or image set on which a video is to be based), media generator 130 may generate a camera movement parameter by randomly selecting one of a predefined set of camera movement types (e.g., close-up, pan, zoom, or static).

An AI agent orchestrator 230 (e.g., AI agent orchestrator 144 of FIG. 1) operates on at least some of the audience parameter(s) in audience segment data 202 and product parameter(s) in product data 204, and possibly on mapped parameter(s) from parameter mapping 220 (and/or parameter(s) generated without parameter inputs), to generate a creative brief for the media content. The AI agent orchestrator 230 may also select and/or analyze assets from asset library 206, analyze web crawl data 208, and/or analyze compliance data 210 when generating the creative brief, depending on the implementation. The creative brief generally comprises a concise but detailed text description of the media content to be generated. For example, the creative brief may describe the setting for an image or video, appearance/actions of characters that are to appear in an image or video, the scenario (e.g., sequence of actions/movements, storyline, etc.) that is to unfold in a video, cinematic techniques to be used in an image or video (e.g., lighting types, shot selections, etc.), and so on. In some implementations, the creative brief provides a text description of a video, but the AI agent orchestrator 230 uses the creative brief to generate images (e.g., start/end frames of different scenes and/or shots, and/or of the video as a whole) that will be used with subsequent tweening techniques (e.g., by an agent of media generator 130) to fill in the remaining frames of the video. For example, such images might reflect a particular camera technique type by virtue of a starting image for a shot being centered on a first location and/or at a first zoom level, and an ending image for the shot being centered on a different, second location (e.g., for a panning technique) and/or at a different, second zoom level (e.g., for a zooming technique).

To generate the creative brief, AI agent orchestrator 230 utilizes AI agents (based on AI agent models 150) in a specific, orchestrated manner. For example, AI agent orchestrator 230 may execute Python code that calls various ones of the AI agents in a particular sequence (or with some in parallel, etc.) and populates prompt templates for particular AI agents using the various inputs (e.g., from elements 202, 204, 206, 208, and/or 210) and, in some cases, outputs of other AI agents. In some implementations, the functionality of AI agents, and/or of the AI agent orchestrator 230 as a whole, is provided as a cloud-based service, and/or using a microservices architecture in which the AI agent orchestrator 230 calls for services from particular ones of AI agents (e.g., via application programming interfaces (APIs) exposed by the AI agents) as needed. Operation of the AI agent orchestrator 230, in various implementations, is further discussed below in connection with FIGS. 3-5.

At a media generation 240 stage, the media generator 130 generates the media content based on the creative brief. For example, media generator 130 may apply the creative brief (possibly after some editing or other processing) as a prompt to a T2V model of models 152, which in response creates and outputs the desired video. As another example, media generator 130 may apply the creative brief or an edited/processed version thereof as a prompt to a T2I model of models 152, which in response generates starting and/or ending images/frames for one or more scenes or shots (or just for the video as a whole). At a compliance check 250 stage, media generator 130 automatically checks for compliance of the generated media content, e.g., based on compliance data 210. The compliance check 250 may include, for example, analyzing the media content with an additional AI agent that is prompted with the compliance data and instructions to enforce the guidelines, rules, regulations, etc., reflected by the compliance data 210. In some implementations, compliance check 250 is omitted. For example, one or more of the AI agents may use the compliance data 210 as context (e.g., additional prompt information) to help ensure that compliance is enforced by the creative brief, rather than checking compliance after media content generation (the latter potentially being more costly due to the need to create new media content if initial media content is non-compliant). In still other implementations, compliance is achieved or facilitated by incorporating redundancy, e.g., by providing compliance data 210 to one or more of the AI agents and also performing compliance check 250 on the generated video.

At a quality assessment 260 stage, quality assessment engine 148 (or an engine implemented by a different computing system, etc.) uses QA models 154 to assess quality (e.g., cinematic quality) of the generated media content. The quality assessment 260 may include generating feedback (e.g., as shown by one or both dashed lines in FIG. 2) indicating one or more characteristics of subject matter of the media content that impair the quality of the media content (e.g., limb/object fusion or other artifacts, poor composition, poor lighting, bland facial expressions, inappropriate camera movements or zoom levels, etc.), and/or indicating whether the quality of the media content is satisfactory, for example. Further detail of the quality assessment 260 stage, according to various implementations, is provided below in connection with FIG. 6. In some implementations, the quality assessment 260 includes (e.g., inherently includes) the compliance check 250, or the compliance check 250 instead occurs after the quality assessment 260, etc.

In still other implementations, the quality assessment 260 additionally or alternatively includes (or another, distinct stage includes) post-production monitoring of (e.g., collecting and/or calculating of) performance metrics such as impression rate, click-through rate, and/or conversion rate, based on user (e.g., potential customer) interactions with the media content when the media content serves as a digital advertisement (e.g., as pre-roll or mid-roll ads in other videos, or as a display ad on web pages, etc.). Such performance metrics may be used to modify prompts to one or more AI agents, and/or to retrain one or more AI agents, etc. Additionally or alternatively, in some implementations, the quality assessment 260 or another stage includes using a machine learning model to predict a performance metric (e.g., click-through rate, etc.) of the media content. Other types of assessment operations are also possible.

Media generator 130 may use output(s) of the quality assessment 260 as feedback to modify prompts to one or more of the AI agents, to modify (e.g., retrain) one or more of the AI agents themselves, and/or for other operations, for future use (e.g., to iteratively generate new media content for the same product and same audience, and/or to more generally improve performance for media content pertaining to other products and/or audiences). Moreover, media generator 130 may aggregate the outputs of the quality assessment 260 across different media content items, and use statistics relating to the aggregate output to modify one or more of the AI agents and/or other operations. As one example, media generator 130 may use an LLM to modify the prompt to one or more of the AI agents based on the feedback (e.g., add a prompt instruction to make the scenario more suspenseful in response to feedback data indicating that consumers skip or exit the video after a short amount of time), e.g., as discussed further below with reference to FIG. 6. As another example, media generator 130 may modify the rules or algorithms of parameter mapping 220 based on the feedback from quality assessment 260, and/or based on other feedback (e.g., in the above tone parameter example, change the upper limit of the first age range from 24 to 25 in response to consumer feedback indicating that consumers that are 25 years old tend to find generated video advertisements to be “boring”).

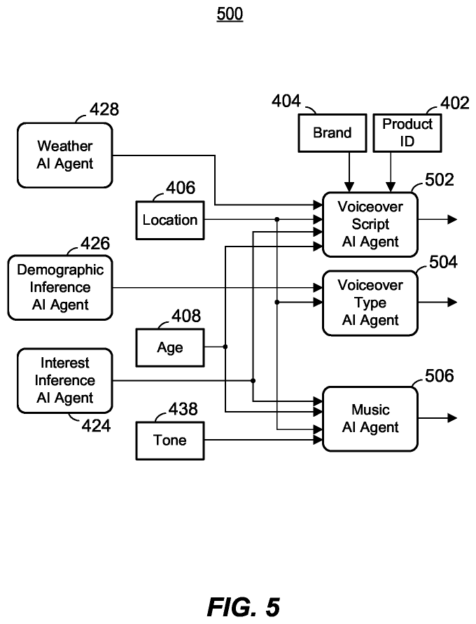

FIGS. 3-5 depict example AI agent architectures that may be implemented by the AI agent orchestrator 144 of FIG. 1 or the AI agent orchestrator 230 of FIG. 2 to generate a video. As noted above, however, this may be accomplished by using the AI agent orchestrator 144 or 230 to generate individual images/frames, and then using tweening techniques to fill in the gaps between the images/frames. In still other implementations, the AI agent architectures of any of FIGS. 3-5 (or modified versions thereof) may be used to generate a still image as a final product (e.g., with the architecture of FIG. 5 being used to generate a voiceover that accompanies the still image).

FIG. 3 depicts an example AI agent architecture 300 that operates on inputs that include one or more product parameters 302 (e.g., from product data 204) and one or more audience parameters 304 (e.g., from audience segment data 202), and includes a product description AI agent 310, an audience inference AI agent 312, a setting AI agent 320, a scenario AI agent 322, a character AI agent 326, a technique AI agent 330, a creative brief AI agent 332, a music AI agent 340, and a voiceover AI agent 342.

The product description AI agent 310 (e.g., an LLM-based and/or MLLM-based agent) processes/analyzes one or more of the product parameter(s) 302 to generate one or more product descriptors. For example, AI agent orchestrator 230 may populate a prompt template with the product parameter(s) 302 (e.g., a product name and/or brand name), and input the resulting prompt to product description AI agent 310 to generate a visual description of the product, and/or a description of how the product is typically used. In some implementations, product description AI agent 310 is an MLLM-based agent, and accepts as input both the prompt and one or more digital assets from asset library 206. For example, the input to product description AI agent 310 may include a set of one or more images of the product from asset library 206, and the prompt may instruct the product description AI agent 310 to generate a text description of the visual appearance of the product depicted in the image(s).

The audience inference AI agent 312 (e.g., an LLM-based or MLLM-based agent, and/or an agent utilizing classifier neural networks, etc.) processes/analyzes one or more of the audience parameter(s) 304 to output one or more inferred characteristics of the audience. For example, AI agent orchestrator 230 may populate a prompt template with the audience parameter(s) 304 (e.g., a location and age range for an intended audience), and input the resulting prompt to audience inference AI agent 312 to infer the audience characteristic(s). Examples of inferred characteristics include demographic characteristics of the audience that are not specified by the audience parameter(s) 304, interests of the audience (e.g., hobbies, activities, etc.), values of the audience, architectural styles of residences of members of the audience, weather in locales where members of the audience live, income levels of members of the audience, etc.

The setting AI agent 320 (e.g., an LLM-based and/or MLLM-based agent) processes/analyzes one or more product descriptors generated by product description AI agent 310, one or more audience characteristics inferred by audience inference AI agent 312, one or more mapped parameters 324 (e.g., a tone parameter mapped from an age parameter as discussed above), and possibly other information (e.g., one or more of product parameter(s) 302 and/or audience parameter(s) 304) to generate a setting descriptor. For example, AI agent orchestrator 230 may populate a prompt template with the product descriptor(s), inferred audience characteristic(s), and mapped parameter(s) 324, and input the resulting prompt to setting AI agent 320 to generate the setting descriptor.

The scenario AI agent 322 (e.g., an LLM-based and/or MLLM-based agent) processes/analyzes one or more product descriptors generated by product description AI agent 310, one or more audience characteristics inferred by audience inference AI agent 312, the setting descriptor generated by setting AI agent 320, and possibly other information (e.g., one or more of product parameter(s) 302 and/or audience parameter(s) 304, and/or one or more of mapped parameter(s) 324) to generate a scenario descriptor. For example, AI agent orchestrator 230 may populate a prompt template with the product descriptor(s), inferred audience characteristic(s), and setting descriptor, and input the resulting prompt to scenario AI agent 322 to generate the setting descriptor.

The character AI agent 326 (e.g., an LLM-based and/or MLLM-based agent) processes/analyzes one or more of the audience parameter(s) 304, and possibly other information (e.g., one or more audience characteristics inferred by audience inference AI agent 312 and/or one or more of mapped parameter(s) 324) to generate a character descriptor (e.g., a description of a character's visual appearance, such as the character's hairstyle, body type, clothing style, etc.). For example, AI agent orchestrator 230 may populate a prompt template with the audience parameter(s) (e.g., location and age), and input the resulting prompt to character AI agent 326 to generate the character descriptor. In some implementations, AI agent orchestrator 230 (e.g., using character AI agent 326 itself or another AI agent) determines whether to generate a character descriptor for a given video based on one or more factors. For example, an additional input to character AI agent 326 may be the scenario descriptor generated by scenario AI agent 322, and character AI agent 326 may decide to output a null descriptor (or AI agent orchestrator 230 may simply bypass character AI agent 326 entirely, etc.) in response to determining that the scenario descriptor does not describe any human characters.

The technique AI agent 330 (e.g., an LLM-based and/or MLLM-based agent) processes/analyzes one or more of the mapped parameter(s) 324 (e.g., a tone parameter), one or more audience characteristics inferred by audience inference AI agent 312, the setting descriptor generated by setting AI agent 320, and possibly other information (e.g., one or more of the product parameter(s) 302) to generate a technique descriptor (e.g., describing an establishment shot to open the video, a lighting technique, color grading, a shot composition, etc.). For example, AI agent orchestrator 230 may populate a prompt template with the inferred audience characteristic(s) (e.g., inferred weather for the audience location), a tone parameter, and the setting descriptor, and input the resulting prompt to technique AI agent 330 to generate the technique descriptor.

The creative brief AI agent 332 (e.g., an LLM-based and/or MLLM-based agent) processes/analyzes parameters 334 (e.g., including one or more of the product parameter(s) 302, audience parameter(s) 304, mapped parameter(s) 324 such as a tone parameter, etc.), the product descriptor generated by product description AI agent 310, one or more audience characteristics inferred by audience inference AI agent 312, the setting descriptor generated by setting AI agent 320, the scenario descriptor generated by scenario AI agent 322, the character descriptor generated by character AI agent 326, the technique descriptor generated by technique AI agent 330, and possibly also other information, to generate the creative brief. For example, AI agent orchestrator 230 may populate a prompt template with the above-noted parameters, characteristics, and descriptors, and input the resulting prompt to creative brief AI agent 332 to generate the creative brief.

The music AI agent 340 (e.g., an LLM-based and/or MLLM-based agent) processes/analyzes one or more audience characteristics inferred by audience inference AI agent 312 (e.g., an interest or affinity), and possibly other information (e.g., a tone parameter of mapped parameter(s) 324) to output a music selection (e.g., a category/type of music) to accompany the video. For example, AI agent orchestrator 230 may populate a prompt template with the inferred audience characteristic(s), and then input the resulting prompt to music AI agent 340 to generate a music descriptor. As another example, the music AI agent 340 may be a neural network classifier that operates on features (e.g., audience characteristic(s)) that are not in text form.

The voiceover AI agent 342 (e.g., an LLM-based and/or MLLM-based agent) processes/analyzes one or more audience characteristics inferred by audience inference AI agent 312 (e.g., an interest or affinity), and possibly other information (e.g., a tone parameter of mapped parameter(s) 324) to output voiceover information (e.g., a voiceover script, and possibly a particular type of voice for the voiceover, etc.) to accompany the video. For example, AI agent orchestrator 230 may populate a prompt template with the inferred audience characteristic(s), and then input the resulting prompt to voiceover AI agent 342 to generate a voiceover script and/or voiceover type parameter.

It is understood that in various implementations, architecture 300 may may include more or fewer AI agents, and that the AI agents shown in FIG. 3 may process more, fewer, and/or different inputs than are shown in FIG. 3, or provide more than a single output (e.g., output multiple descriptors), etc. In some implementations, for example, one or more of the AI agents shown in FIG. 3 make use of digital assets from asset library 206, web crawl data 208, and/or compliance data 210 from FIG. 2 (e.g., by AI agent orchestrator 230 adding the data to the respective prompt template(s), and/or providing one or more digital assets as input to an AI agent that includes an MLLM). In one such implementation, product description AI agent 310 analyzes compliance data 210 to ensure that the generated product descriptor does not describe any impermissible usage of the product, scenario AI agent 322 and character AI agent 326 analyze compliance data 210 to ensure that the generated scenario descriptor and character descriptor, respectively, do not describe actions that run afoul of brand safety guidelines, and so on. As another example, scenario AI agent 322 may analyze web crawl data 208 to ensure that the generated scenario descriptor does not describe a scenario corresponding to a recent negative news event, and/or technique AI agent 330 may analyze web crawl data 208 to learn and possibly apply new or trending film techniques (e.g., recently trending lighting or shot composition techniques). As yet another example, music AI agent 340 may analyze web crawl data 208 to identify a category of music that is currently popular.

In still other implementations, the architecture 300 includes a different breakdown of specifically trained AI agents, such as: a director AI agent for creative strategy and storytelling (e.g., to determine emotional tone, storytelling approach, and visual pacing, choose narrative structure optimized for engagement on digital platforms, and learn from high-performing ads to refine storytelling techniques dynamically); a cinematographer AI agent for shot composition and camera work (e.g., to select the best framing, angles, and camera movement based on emotional impact, use tracking shots, handheld, dolly, or drone style cinematography for cinematic quality, and adjust shot selection based on engagement metrics per platform); a set director AI agent for environment and backgrounds (e.g., to design ad locations and set aesthetics to align with brand identity, enhance visual storytelling through composition, minimalism, or dynamic environments, and adapt backgrounds and set designs based on data-driven performance analysis); a wardrobe director AI agent for fashion and costume design for branding (e.g., to select clothing and fashion elements to reinforce brand perception, match color psychology to campaign objectives, and adjust wardrobe choices dynamically based on cultural and regional considerations); a lighting and colorist AI agent for mood and atmosphere (e.g., to control lighting schemes and color grading for emotional impact, choose between natural, high-contrast, or stylistic lighting based on brand messaging, and use AI-driven look-up tables to enhance brand identity across platforms); a post-production AI agent for editing and refinement; a copywriter AI agent for voiceover script, taglines, and/or call-to-action optimization (e.g., to write ad scripts optimized for conversion and engagement, develop compelling calls to action tailored to audience psychology, and auto-generate variations for A/B testing and performance improvement); a sound designer AI agent for audio optimization (e.g., to add immersive sound effects, transitions, and background scores, optimize music selection for emotional and brand alignment, and ensure balance between dialogue, effects, and background sound); an editor AI agent for final pacing, transitions, and exporting (e.g., to cut footage for maximum retention and emotional resonance, use match cuts, jump cuts, and montage techniques to enhance storytelling, and optimize final ad format for different digital platforms); and a linguist AI agent for translation and cultural adaptation (e.g., to translate ads into multiple languages while preserving brand tone, adapt messaging and cultural nuances to resonate with regional audiences, and ensure compliance with local advertising regulations and sentiment analysis).

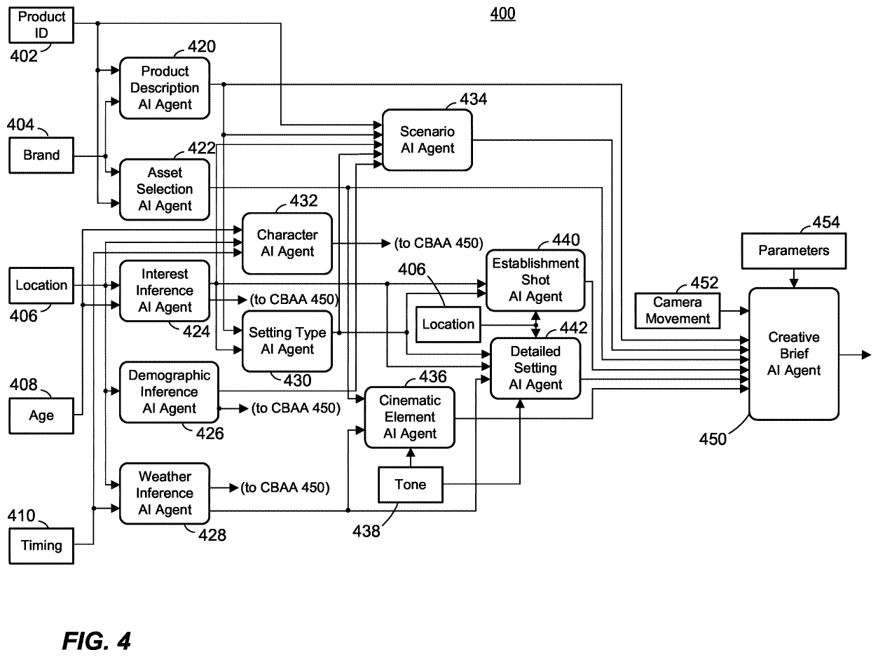

FIG. 4 depicts another example AI agent architecture 400 that is specifically for a visual component of a video. The architecture 400 may be a more granular view of one implementation of the visual component portion of architecture 300 of FIG. 3 (e.g., with product ID parameter 402 and brand parameter 404 being subsets of product parameter(s) 302, location parameter 406 and age parameter 408 being subsets of audience parameter(s) 304, interest inference AI agent 424 and demographic inference AI agent 426 being components within audience inference AI agent 312, etc.), for example.

The example AI agent architecture 400 operates on inputs that include a product ID parameters 402 (e.g., a name of a product or code identifying the product), a brand parameter 404 (e.g., a name of the brand under which the product is offered, and possibly other parameters such as a brand color), a location parameter 406 (e.g., a country, state, city, region, or other geographical identifier identifying the location of an intended or expected audience for the product), and an age parameter 408 (e.g., an age or age range of the audience), and a timing parameter 410 (e.g., the current date or season, or the date or season of an expected launch of the product). AI agents within the example architecture 400 include a product description AI agent 420, an asset selection AI agent 422, an interest inference AI agent 424, a demographic inference AI agent 426, a weather inference AI agent 428, a setting type AI agent 430, a character AI agent 432, a scenario AI agent 434, a cinematic element AI agent 436, an establishment shot AI agent 440, a detailed setting AI agent 442, and a creative brief AI agent 450.

The product description AI agent 420 (e.g., an LLM-based and/or MLLM-based agent) processes/analyzes the product ID parameter 402 and brand parameter 404 to generate one or more product descriptors. For example, AI agent orchestrator 230 may populate the following two prompt templates for product description AI agent 420 to obtain a description of the appearance and usage of the product:
Provide a concise and visually descriptive overview of {product ID} from {brand}.
Describe, step-by-step, how someone typically uses the product: {product ID} from {brand}. Be very specific about the actions involved. For this description, do not describe the product's appearance.
   In the above example template, “{product ID}” and “{brand}” are parameters 402 and 404, respectively. The AI agent orchestrator 230 may apply the prompts sequentially to the same LLM, for example, or in parallel to different LLMs that are respectively trained specifically to describe product appearance and product usage, etc.

The asset selection AI agent 422 (e.g., a neural network that outputs a relevance or predicted performance score, or an LLM-based and/or MLLM-based agent, etc.) processes/analyzes the product ID parameter 402 and brand parameter 404, and digital assets within asset library 180 or asset library 206, to select particular digital assets for use in the video (or, in some implementations, for analysis by other AI agents in architecture 400, but not necessarily in the video being generated). For example, asset selection AI agent 422 may analyze a large library of digital assets associated with a particular advertiser, and select one or more images that both (1) portray the product offered under the brand and (2) is/are predicted by a neural network of asset selection AI agent 422 to have a high click-through rate.

The interest inference AI agent 424 (e.g., an LLM-based and/or MLLM-based agent, or a neural network classifier, etc.) processes/analyzes the location parameter 406 and age parameter 408 to generate one or more descriptors and/or classifications of interests (e.g., hobbies, activities, affinities, values, etc.) of the audience. For example, AI agent orchestrator 230 may populate the following prompt template for interest inference AI agent 424 to obtain a description of interests of the audience:
Describe the likely lifestyles and interests of people who live in {location} and are in the age group {age}. Consider their typical activities, hobbies, values, and aspirations.
   In the above example template, “{location}” and “{age}” are parameters 406 and 408, respectively.

The demographic inference AI agent 426 (e.g., an LLM-based and/or MLLM-based agent, or a neural network classifier, etc.) processes/analyzes the location parameter 406 (and possibly age parameter 408) to generate one or more descriptors and/or classifications of demographic characteristics (e.g., income levels) of the audience. For example, AI agent orchestrator 230 may populate the following prompt template for demographic inference AI agent 426 to obtain a description of interests of the audience:
What is the most likely income level of people living at {location}? Provide a likely income level (e.g., High, Middle, Low).
   In the above example template, “{location}” is parameter 406.

The weather inference AI agent 428 (e.g., an LLM-based and/or MLLM-based agent, or a neural network classifier, etc.) processes/analyzes the location parameter 406 and timing parameter 410 to generate a descriptor and/or classification of current weather where the audience resides. For example, AI agent orchestrator 230 may populate the following prompt template for weather inference AI agent 428 to obtain a description of interests of the audience:
Describe the typical weather conditions in {location} around {timing}. Be specific about temperature, sky conditions (sunny, cloudy, rainy, etc.), and any other relevant weather phenomena (fog, snow, wind, etc.).
   In the above example template, “{location}” and “{timing}” are parameters 406 and 410, respectively.

The setting type AI agent 430 (e.g., an LLM-based and/or MLLM-based agent, or a neural network classifier, etc.) processes/analyzes the product descriptor(s) output by product description AI agent 420 and the descriptor(s) output by the interest inference AI agent 424 to generate a descriptor and/or classification of a type of setting for the video being generated. For example, AI agent orchestrator 230 may populate the following prompt template for setting type AI agent 430 to obtain a description of a setting type:
Choose the one of the following settings that is the most logical and most realistic location for a product described as {product descriptor}, considering the product is being used by someone with {interest descriptor}. Consider where someone would naturally use the product.
   Kitchen
   Gaming Area (desk with computer, gaming chair, etc.)
   Living Room
   Bedroom
   Outdoors (specify type, e.g., park, street, garden).
      In the above example template, “{product descriptor}” and “{interest descriptor}” are outputs (or portions of outputs) of AI agents 420 and 424, respectively.

The character AI agent 432 (e.g., an LLM-based and/or MLLM-based agent) processes/analyzes the location parameter 406, the age parameter 408, and the timing parameter 410 (and possibly the outputs of AI agents 424 and/or 426) to generate a descriptor of one or more characters that will or may appear in the video being generated. For example, AI agent orchestrator 230 may populate the following prompt template for character AI agent 432 to obtain a description of a character:
Describe the typical appearance of a {age} person living in {location} during {timing}. Focus on current trends, and include details about:
   Hairstyle
   Facial hair (if applicable)
   Clothing style
      In the above example template, “{age}”, “{location}”, and “{timing}” are parameters 408, 406, and 410, respectively.

The scenario AI agent 434 (e.g., an LLM-based and/or MLLM-based agent) processes/analyzes the product ID parameter 402, the descriptor(s) output by product description AI agent 420, the descriptor(s) output by the interest inference AI agent 424,the descriptor output by setting type AI agent 430, and the descriptor output by demographic inference AI agent 426 to generate a descriptor of a scenario for the video being generated. For example, AI agent orchestrator 230 may populate the following prompt template for scenario AI agent 434 to obtain a description of a scenario:
Describe a realistic and visually interesting scenario where someone is:
   Primarily engaged in: {activity}
   In this setting: {setting type}
   And also uses the product: {product ID} ({product_usage})
      In the above example template, “{activity}” is a portion of the interest descriptor(s) output by interest inference AI agent 424, {“setting type}” is the setting type descriptor output by the setting type AI agent 430, “{product ID}” is the product ID parameter 402, and “{product usage}” is a portion of the product descriptor(s) outputs by the product description AI agent 420.

The cinematic element AI agent 436 (e.g., an LLM-based and/or MLLM-based agent) processes/analyzes the descriptor output by weather inference AI agent 428, a tone parameter 438 (e.g., mapped from age parameter 408 by mapping module 142), and possibly one or more digital assets selected by asset selection AI agent 422 to generate a descriptor of one or more cinematic elements of the video being generated. For example, AI agent orchestrator 230 may populate the following prompt template for cinematic element AI agent 436 to obtain a description of cinematic elements:
Describe the cinematic elements of a scene with the following characteristics:
   Overall Tone: {tone}
   Weather: {weather descriptor}
   Brand Colors: {brand colors}
Provide specific descriptions for:
   Lighting: (e.g., “soft, diffused light with cool undertones,” “high-contrast lighting with dramatic shadows”)
   Color Grading: (e.g., “muted colors with a desaturated look,” “vibrant colors with a warm, golden hue”)
   Shot Composition: (e.g., “close-up on the subject's face, ” “shallow depth of field”)
      In the above example template, “{tone}” is a parameter mapped from age parameter 408 (e.g., as discussed above in connection with FIG. 3), “{weather descriptor}” is the descriptor output by weather inference AI agent 428, and “{brand colors}” are one or more brand colors that media generator 130 identifies by analyzing one or more of the assets selected by asset selection AI agent 422 (or based on a brand color parameter included with brand parameter 404, etc.).

The establishment shot AI agent 440 (e.g., an LLM-based and/or MLLM-based agent) processes/analyzes the descriptor output by interest inference AI agent 424 and the descriptor output by setting type AI agent 430 to generate a descriptor of an establishing shot (e.g., opening shot) for the video being generated. For example, AI agent orchestrator 230 may populate the following prompt template for establishment shot AI agent 440 to obtain a description of the establishing shot:
Describe a visually compelling establishing shot for an 8 second video, set in {location}. The shot should showcase the architecture and atmosphere typical of {location}.
   Setting: {setting type}
Include details like the time of day, the type of buildings (if any), and any distinctive features of the cityscape or landscape (if any).
   In the above example template, “{location}” is the location parameter 406 and “{setting type}” is the descriptor output by setting type AI agent 430.

The detailed setting AI agent 442 (e.g., an LLM-based and/or MLLM-based agent) processes/analyzes the location parameter 406, the descriptor output by setting type AI agent 430, the descriptor(s) output by the interest inference AI agent 424, the descriptor output by the weather inference AI agent 428, and tone parameter 438 to generate a more detailed setting descriptor for the video being generated. For example, AI agent orchestrator 230 may populate the following prompt template for detailed setting AI agent 442 to obtain a detailed description of the setting:
Describe a {setting type descriptor} in {location}. Consider the following:
Time of Day: {time of day}
Weather: {weather descriptor}
Overall Tone: {tone}
Provide a description that is both visually rich and concise. Focus on details relevant to the setting and the overall tone. Do NOT mention any characters or actions. Focus on the environment.
   In the above example template, “{setting type descriptor}” is an output of setting type AI agent 430, “{location}” is location parameter 406, “{time of day}” is timing parameter 410 (or an inferred time of day generated by another AI agent not shown in FIG. 4, etc.), “{weather descriptor}” is an output of weather inference AI agent 428, and “{tone}” is tone parameter 438.

The creative brief AI agent 450 (e.g., an LLM-based and/or MLLM-based agent) processes/analyzes parameters 454 (e.g., one, some, or all of parameters 402, 404, 406, 408, 410), a camera movement parameter 452 (e.g., a pre-defined category of camera movement type, such as pan, zoom, close-up, etc., that media generator 130 randomly or otherwise selects), digital asset(s) selected by asset selection AI agent 422 (e.g., if creative brief AI agent 450 is an MLLM), and the descriptors output by product description AI agent 420, interest inference AI agent 424, demographic inference AI agent 426, weather inference AI agent 428, character AI agent 432, scenario AI agent 434, cinematic element AI agent 436, establishment shot AI agent 440, and detailed setting AI agent 442 to generate a creative brief that thoroughly but concisely describes various aspects of the video being generated. In some implementations, certain AI agents (e.g., AI agents 424, 426, 428, and/or 430) only generate intermediate inferences and thus their outputs may not be directly input to or analyzed by creative brief AI agent 450. By including various inputs using descriptors that were concisely and clearly specified by the various AI agents (e.g., AI agents 420, 434, 436, 440, and 442), one or more of T2I/T2V models 152 can output a video with visual consistency over time and that accurately portrays the product, setting, sequence of actions, etc., in a manner that can maintain high cinematic quality and attract/maintain viewer interest. In some implementations, creative brief AI agent 450 includes a first AI agent configured to generate the full video description in detail, and a second AI agent configured to accept the full video description as input and output a concise description in a format particularly well-suited to the model type(s) for the T2I/T2V models 152.

FIG. 5 depicts an example AI agent architecture 500 that is specifically for an audio component of a video (e.g., audio for a video generated using architecture 400). The AI agent orchestrator 144 or AI agent orchestrator 230 may implement architectures 400 and 500 in parallel to generate the visual and audio components of a single video.

The example AI agent architecture 500 operates on inputs that include product ID parameter 402, brand parameter 404, location parameter 406, age parameter 408, and tone parameter 438 (each discussed above in connection with FIG. 4). AI agents within the example architecture 500 include interest inference AI agent 424, demographic inference AI agent 426, and weather inference AI agent 428 (each discussed above in connection with FIG. 4), as well as a voiceover script AI agent 502, a voiceover type AI agent 504, and a music AI agent 506.

The voiceover script AI agent 502 (e.g., an LLM-based and/or MLLM-based agent) processes/analyzes the product ID parameter 402, the brand parameter 404, the location parameter 406, the age parameter 408, the descriptor output by weather inference AI agent 428, and the descriptor(s) and/or classifications output by interest inference AI agent 424 (and possibly tone parameter 438, etc.) to generate a text script for a voiceover to the video, which media generator 130 can then input to a text-to-speech module to create the needed audio. For example, AI agent orchestrator 230 may populate the following prompt template for voiceover script AI agent 502 to obtain a script for a short (e.g., 8-second) video:
Generate a concise, one-sentence advertising tagline for the following:
   Brand: {brand}
   Product: {product ID}
   Location: {location}
   Age Range: {age}
   Affinity: {affinity}
   Weather: {weather descriptor}
Create a tagline that connects the product to the audience's lifestyle and aspirations. Make it memorable and engaging.
   In the above example template, “{brand}” is the brand parameter 404, “{product ID}” is the product ID parameter 402, “{location}” is the location parameter 406, “{age}” is the age parameter 408, “{affinity}” is an inferred interest from a descriptor output by interest inference AI agent 424, and “{weather descriptor}” is the descriptor output by weather inference AI agent 428.

The voiceover type AI agent 504 (e.g., an LLM-based and/or MLLM-based agent, or a neural network classifier, etc.) processes/analyzes the location parameter 406 and the descriptor output by demographic inference AI agent 426 (and possibly age parameter 408, tone parameter 438, etc.) to generate a descriptor and/or classification for a type of voice for the voiceover to the video. The media generator 130 may input the voiceover type to the text-to-speech module along with the voiceover script when creating the audio, for example.

The music AI agent 506 (e.g., an LLM-based and/or MLLM-based agent, or a neural network classifier, etc.) processes/analyzes the location parameter 406, the age parameter 408, the tone parameter 438, and a descriptor or classification output by interest inference AI agent 424 to generate a descriptor and/or classification indicating a type of music to play with the video (e.g., in addition to the voiceover). For example, AI agent orchestrator 230 may populate the following prompt template for music AI agent 506:
Based on the following information, suggest one suitable music genre for a video advertisement:
   Location: {location}
   Age Range: {age}
   Affinity: {affinity}
   Tone: {tone}
Provide only the genre (e.g., “Classical”, “Electronic”, “Pop”, “Indie”).
   In the above example template, “{location}” is the location parameter 406, “{age}” is the age parameter 408, “{affinity}” is an inferred interest from a descriptor output by interest inference AI agent 424, and “{tone}” is the tone parameter 438. In some implementations, the computing system 102 (or an entity associated with client device 104) stores a collection of authorized audio music files each corresponding to a particular genre, and media generator 130 selects a particular music file (e.g., randomly) matching the genre indicated by music AI agent 506.

It is understood that in various implementations architectures 400 and/or 500 may may include more or fewer AI agents than are shown, and that the AI agents shown in FIGS. 4 and/or 5 may process more, fewer, and/or different inputs than are shown, or provide more than a single output (e.g., output multiple descriptors of a voiceover type, or multiple musical characteristics/classifications), etc. In some implementations, for example, product description AI agent 420 analyzes compliance data (e.g., compliance data 210) to ensure that the generated product descriptor(s) do not describe any impermissible usage of the product, scenario AI agent 434 and character AI agent 432 analyze the compliance data to ensure that the generated scenario descriptor and character descriptor, respectively, do not describe actions that run afoul of brand safety guidelines, and so on. As another example, scenario AI agent 434 may analyze current event data (e.g., in web crawl data 208) to ensure that the generated scenario descriptor does not describe a scenario corresponding to a recent negative news event, and/or cinematic element AI agent 436 and/or establishment shot AI agent 440 analyze film technique data (e.g., in web crawl data 208 or supplied via client device 104, etc.) to learn and possibly apply new or trending film techniques (e.g., recently trending lighting or shot composition techniques). As yet another example, music AI agent 506 may analyze trend data (e.g., in web crawl data 208) to identify a category of music that is currently popular in a location corresponding to location parameter 406.

When used on a large scale, parameter-driven AI media content generation, such as in the techniques of the present disclosure, can inherently risk so-called “content convergence,” with visual redundancy across different media content items. In particular, identical or highly similar parameter sets can, despite subtle variations, produce strikingly similar output. Such lack of diversity can be problematic in numerous respects, such as undermining brand differentiation, diminishing audience engagement, and so on. To mitigate such problems, in some implementations, the media generator 130 (e.g., AI agent orchestrator 144) may perform one or more operations that help ensure a greater diversification of generated media content, and/or greater diversification of specific components of the media content (e.g., a greater variety of scenes, more varied lighting techniques, etc.).

Specifically, in some implementations, media generator 130 mitigates such problems by using encoded source vectors, with a given source vector including a plurality of elements (e.g., digits), and with each element representing a discrete, indexed source (e.g., media content aspect) within a pre-defined prompt structure lexicon. For example, each element may correspond to a media content generation aspect handled by a different agent of the AI agents orchestrated by AI agent orchestrator 144, or to a different task of a single AI agent, etc. As a more specific example, an example source vector may be “1857”, where “1” corresponds to establishment shot, “8” corresponds to camera angle, “5” corresponds to camera motion, and “7” corresponds to lighting.

When generating a media content item (e.g., video or image), the media generator 130 may apply each of the encoded source vector elements as a seed for the LLM or other model (e.g. one of AI agent models 150) that handles the corresponding aspect. Each element/seed effectively inserts a degree of randomness into the high-dimensional prompt space for the model, and thus guides the model towards diverse, yet coherent, visual outputs. The approach enables the media generator 130 to implement or apply granular (element-wise), algorithmic control over prompt variations, ensuring that each generated video or image possesses a unique visual signature. In some implementations, the media generator 130 systematically iterates through the source vector space when generating successive media content items, which provides a form of constrained random sampling within the high-dimensional prompt space and helps to guarantee combinatorial diversity and effectively mitigate media content redundancy. The media generator 130 may access (e.g., in memory 124) a mapping (e.g., table, legend, dictionary, etc.) indicating the source/aspect to which each element refers. Using such a technique, the details of any given video or image can be unique even with identical high-level parameters. In some implementations, the media generates a given source code vector, with elements for lower-level parameters such as camera angle, camera motion, shot angle, etc., based on one or more higher-level parameters such as audience location, age, and/or gender, and/or product type, etc.

FIG. 6 depicts an example process 600 that may be implemented by the quality assessment engine 148 of FIG. 1, in conjunction with an actor agent (e.g., an agent of media generator 130 that uses a T2I or T2V model of models 152 to generate media content based on the creative brief, or another suitable actor agent). While other quality assessment engines may instead be used, the process 600 is described here with reference to components of FIG. 1 for ease of reference.

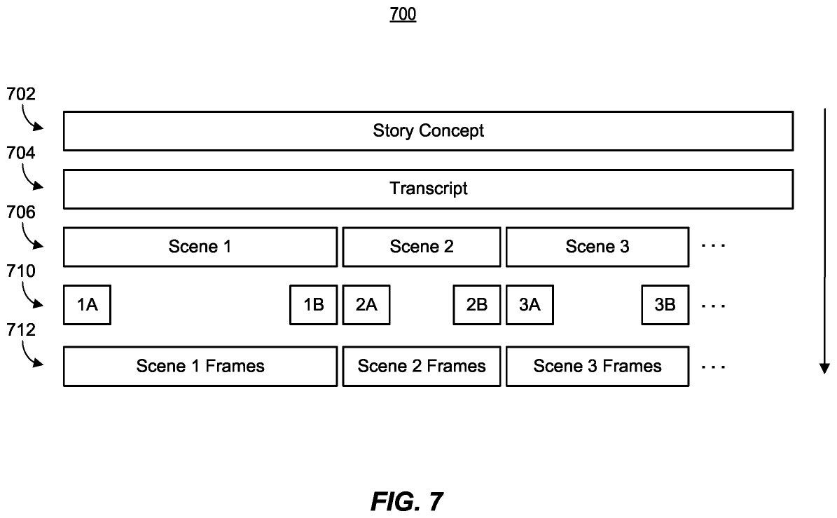

At stage 602 of the process 600, the quality assessment engine 148 applies a media generation prompt 606 (text prompt) to an actor agent that, in response, generates media content 604 (e.g., a video, an image, or a set of multiple images). In some implementations and/or scenarios, the media content 604 includes a batch of images (e.g., four images) that relate to different start or end images to be used in a tweening process (e.g., as discussed below with reference to FIG. 7).

As just one example, the media generation prompt 606 may initially include a creative brief that states:
9:16 Vertical, Ultra-photorealistic Cinematic Photograph.
Absolute, non-negotiable full-body frame: Capture the entire figure head-to-toe, ensuring both clean white athletic trainers are fully visible (one planted, one mid-swing) on the paved pathway, with a generous, clearly visible margin of ground existing below the lowest foot.
Zero tolerance for cropping any part of the subject.
Young adult woman (~21), slender toned athletic build. Long, straight, center-parted hair lifted subtly by motion, showing natural flyaways; striking light blue-grey eyes locked forward with a confident, engaging gaze.
Frozen precisely at the peak of a fluid, energetic outdoor walking stride, embodying graceful forward momentum. Demonstrates natural contrapposto/subtle torso rotation: left foot firmly planted, right leg swinging forward powerfully and smoothly from the hip, knee naturally bent, right foot clearly depicted mid-air before landing.
Arms swing rhythmically in clear opposition, elbows bent comfortably (~90 degrees), held distinctly away from the body: left arm swings forward, relaxed hand (fingers gently curved) clearly visible forward of her left hip; right arm swings back naturally, held slightly outward, relaxed hand clearly visible beside/slightly behind her right hip. The entire posture conveys effortless balance and dynamic, authentic motion.
Form-fitting white sleeveless high-neck crop top; matching high-waisted tight white athletic shorts (premium matte performance stretch fabric conforming smoothly/flatteringly, minimizing unnatural bunching/creasing, slight realistic puckering only around fastened vertical rows of small, dark metallic studs); the trainers.
Scene: A sun-dappled paved park pathway curving gently into the distance, bordered by lush, varied green foliage and occasional flowering bushes in soft focus, creating depth.
Lighting: Crisp, directional golden hour sunlight casting defined short shadows, sculpting form.
Camera & Quality: Full-frame DSLR aesthetic, 85 mm f/1.8 prime simulation; ultra-fast shutter speed rendering flawless detail; absolute, uniform tack-sharp focus across the entire subject, guaranteeing zero motion blur.
Mood: Confident, energetic yet graceful, dynamically poised, authentic athletic movement.

At stage 608, the quality assessment engine 148 assesses the quality of the generated media content 604. Stage 608 includes applying the media content 604 and a quality assessment prompt to a multimodal generative AI model (e.g., an MLLM) of QA models 154. The quality assessment prompt instructs the multimodal generative AI model to analyze the media content for flaws/deficiencies according to whatever standard(s) or type(s) of “quality” is/are to be assessed. For example, the quality assessment prompt may instruct the multimodal generative AI model to identify and describe specific deficiencies with respect to cinematic quality, with respect to a narrower definition of quality (e.g., the quality of “excitement” or “interest”), with respect to a broader definition of quality (e.g., video quality more generally), and/or with respect to an entirely different definition of quality. The quality assessment prompt may also instruct the multimodal generative AI model to indicate whether quality of the media content 604 is acceptable or should instead be revised/improved, and/or to indicate a bounding box (e.g., rectangle or other polygon) corresponding to specific region(s) of media content 604 that contain the identified deficiencies. In some implementations, the quality assessment prompt instructs the multimodal generative AI model to describe deficiencies (and/or generate a bounding box) if and only if the multimodal generative AI model deems the quality of the media content 604 to be insufficient.

In some implementations, the quality assessment prompt includes one or more specific keywords (e.g., search engine optimization keywords such as names of brands) to guide the analysis of the multimodal generative AI model. Such keywords may trigger or activate learned states of the multimodal generative AI model that are associated with high-quality content (e.g., as determined based on web crawl data 208, etc.). The use of appropriate keywords provides a tautological approach that has been found to be more effective than traditional rule-based methods (e.g. conventional pose estimation techniques), which can often misinterpret or accept flawed imagery.

As one example, the quality assessment prompt may be:
You are an image and media editor for a high-end media production house.
Look for any and all flaws in the attached image, the model, the pose, the hands, the feet, and the activity being performed. Would you be happy to use this as an establishment shot for shooting a scene for a commercial, or for placing this image on a full page advertisement of a magazine?
Be highly critical. Arms, legs, hands, and feet must not penetrate or disappear into solid objects (but pockets and gloves are ok). Proportions of the body and items in the image must be perfect.

### Output Format

Answer with your best judgment as to whether this is deserving of a high production advertisement or model portfolio. If the image is suitable, output
“ok: [brief summary of image content]”
If the image is unsuitable, output
“reject: [brief summary of wy image is unsuitable], box=(x1, y1, x2, y2)” where (x1, y1, x2, y2) is the bounding box of the trouble spots that need fixing.
For the bounding box, use unit coordinates, where (0, 0) is the top left corner and (1, 1) is the lower right corner.
Output only a text string.

Responsive to the quality assessment prompt, the quality assessment engine 148 outputs feedback 610 indicative of quality of the media content 604. In particular, the feedback 610 may indicate (e.g., with text descriptor(s) and/or bounding box(es)) one or more characteristics of subject matter depicted in the media content 604 that impair the quality of the media content 604 (e.g., as quality is assessed based on the keyword(s) in the prompt and other instruction), and possibly an indication of whether the media content 604 is of sufficient/acceptable quality.

In some implementations, the quality assessment prompt causes the multimodal generative AI model to output feedback 610 at two or more levels of generality/granularity. For example, the quality assessment prompt may instruct the multimodal generative AI model to output a detailed breakdown of reasons why the media content 604 fails to be of high quality, in addition to a more concise (e.g., one sentence) summary of the most egregious issues adversely affecting quality of the media content 604. The latter can help the actor agent, in a future iteration of stage 602 and after the prompt modification of stage 612 as discussed below, to better understand the difference between its earlier output (media content 604) and a target region or polytope corresponding to high quality in a high-dimensional feature space.

In some implementations, the quality assessment engine 148 embeds metadata indicative of at least a portion of the feedback 610 in a media data file corresponding to the media content 604 (e.g., using tools such as OpenCV® tools). The quality assessment engine 148 may also embed other relevant metadata, such as data indicative of changes to the media generation prompt 606 that are made based on the feedback 610.

At stage 612, the quality assessment engine 148 uses the feedback 610 to generate a revision prompt for a different generative AI model (e.g., another one of QA models 154) or, in some implementations, for the same generative AI model used at stage 608. In either case, the revision prompt instructs the generative AI model to generate a new, revised media generation prompt (i.e., the media generation prompt 606 but as modified/generated for a next iteration of the process 600). To help the generative AI model determine the appropriate revisions or deviations to make, the revision prompt may include (or otherwise be generated based on) the media generation prompt 606 itself from the current iteration. The revision prompt may also include some or all of the possible text components (descriptor(s)) within the feedback 610 as discussed above, and/or other text based on such text components. As one example, the revision prompt may be:
You are a prompt expert. We are experiencing hallunications and errors in showing how products are being used, in the products themselves, and in other issues caused by the scene (which represents a point in time of an activity). We will later animate the scene forward for approximately 5 seconds of activity, so the first image must be perfect and related to the activity.
I will give you the current prompt, followed by the feedback on what is wrong with it. You also have the history of all the changes we've tried.
I'd like you to carefully consider the feedback. Then, completely rewrite the prompt to avoid the error, be insightful, and all the while maintain the original intent and critically detailed, concise physical attributes of the character and scene.
Here is the current prompt:
{prompt}
Here is the error we've encountered:
{error from feedback}
Here is a history of all the changes we've tried so far and the results based on your analyses:
{short-term history}
In your answer, only provide the best, adjusted prompt that you recommend we try next.

Additionally or alternatively, in some implementations where the feedback 610 includes a bounding box, stage 612 includes applying at least the region of the media content that is within the bounding box to a multimodal generative AI model (e.g., MLLM). For example, if the media content 604 includes an image, stage 612 may include applying the entire image to an MLLM along with coordinates of one or more bounding boxes. The output of stage 612 may be a revised version of the media generation prompt 606, which can then be used for a subsequent iteration of process 600.

In the example implementation of FIG. 6, some or all of the feedback 610 is also input, along with similar feedback from other iterations of assessing other media content items (and possibly also from earlier iterations of assessing the same media content item), to a persistent learning stage 614 that supports online learning. While not shown if FIG. 6, other information may also be input to stage 614, such as a descriptor of the differences in the media generation prompt 606 before and after the feedback 610 is applied at stage 612, and also similar descriptors from other iterations/assessments as noted above. The quality assessment engine 148 generates a learning prompt based on the above-noted information (e.g., the feedback and prompt deltas/differences from multiple iterations/assessments), and applies the learning prompt to a generative AI model (e.g., another one of QA models 154, or the same generative AI model from stage 608 and/or stage 612). In response to the learning prompt, the generative AI model generates/outputs a plurality of concise learnings for improving media content quality. The quality assessment engine 148 then stores these concise learnings in long-term context database 616 (e.g., database 182 from FIG. 1), where they join any previous learnings already in the database 616.

As one example, the learning prompt may be:
We are experiencing problems as we prompt AI image models to create key frames or starting scene images for video. Carefully study the history of our exchange, note the evolution of the prompt, and note patterns in the errors.
Summarize what you've learned from this exchange in one paragraph of 300 characters or less. What would be most useful to know in the future given what you've learned so far about generating cinematic quality images that could appear in national advertisements, digital entertainment, and personal communication?

### Format

The 300 or fewer character paragraph must be of an insight you've gained that is novel to you. Optionally, you can follow with 1-3 concise, summarized examples supporting this insight.

Just a few examples of the many types of concise learnings that may be generated and stored in long-term context database 182 are:
“For dynamic walking shots, ensure sufficient margin below the feet to avoid cropping and clearly depict the ground contact or swing phase of both feet.”
“When rendering athletic wear, emphasize smooth fabric conformity while allowing for realistic puckering only around functional elements like studs or seams to avoid an unnatural ‘plastic’ look.”
“To achieve magazine-quality lighting quality for outdoor scenes, specify ‘crisp, directional golden hour sunlight’to create defined short shadows that sculpt form.”

At each iteration of process 600, including the initial iteration, the media generation prompt 606 may include some or all of the learnings from the long-term context database 616 (or a link/reference thereto, e.g., if retrieval augmented generation (RAG) techniques are used) to enable the generative AI model used at stage 602 to more efficiently and quickly (e.g., with fewer iterations of process 600) generate a high-quality version of media content 604. In this manner, the media generator 130 can progressively refine its understanding of the particular type of quality being assessed (e.g., cinematic quality) over time, and adapt its generation strategy accordingly.

As in the specific example provided above, the media generation prompt 606 may also include or link to a shorter-term context/history associated with any past iterations of the process 600 that relate to the same media content item. Such shorter-term context may be indicative of any past feedback 610 and/or any corresponding past revisions to the media generation prompt 606, e.g., to give the actor agent greater awareness of the changes that have already been tried (successfully or unsuccessfully).

In some implementations, the long-term context database 616 does not include (or at least the media generation prompt 606 does not include) a detailed history of feedback and/or corresponding prompt revisions across multiple media content items. For example, detailed information of that sort may instead be discarded after a given media content item (e.g., image or set of images) is determined (at an iteration of stage 608) to have sufficient quality. Instead using only the sparser, concise learnings helps to effectively smooth out the gradient surface in an optimization problem, akin to trust region calculations in proximal policy optimization (PPO) techniques. It has been found that using only the accumulated concise learnings as long-term context for future runs, rather than using a more complete/detailed history, helps improve performance of the actor agent by mitigating confusion/hallucinations (in addition to decreasing persistent storage requirements). In particular, rather than requiring the generation of over 100 images to arrive at one sufficiently high-quality image, tests show these disclosed techniques may only require the generation of roughly 30 images, or fewer.

In some implementations, the inclusion of concise learnings form database 616 is more selective. For example, the quality assessment engine 148 may select one or more specific learnings from database 616 for inclusion in the revised version of the media generation prompt 606 based on the feedback 610 (e.g., by selecting learnings that are specific to “shot composition” only when the feedback 610 specifies a problem with the shot composition of the media content 604, etc., using suitable techniques such as RAG, vector similarity, etc.).

Any suitable termination condition for the process 600 may be applied by the quality assessment engine 148, such as when the stage 608 output indicates satisfactory quality, the number of iterations reaching a maximum permitted number, the amount of processing time/latency reaching some maximum permitted value, and so on. If quality is insufficient when a termination condition is reached, the media generator 130 may output an error/fail indication.

As noted above, the process 600 can be repeated with multiple iterations for a single media content item (thereby building and leveraging short-term context), and across multiple media content items (thereby building and leveraging long-term context), with the accumulated online learnings enabling the process 600 to effectively and efficiently address challenges of producing high quality (e.g., cinematically appealing, and/or brand-consistent, etc.) media content. The feedback mechanism, informed by multimodal AI analysis, can enable precise issue identification, and corresponding, targeted adjustments to the media generation prompt 606 and thus to the media content 604. The feedback may be viewed as providing a gradient loss, for example, with the rewriting of the prompt over multiple iterations being akin to a stochastic gradient descent technique.

FIG. 7 depicts an example video generation process 700 which may be used in conjunction with techniques of the present disclosure. The process 700 generally flows from top to bottom. In the process 700, the AI agent orchestrator 144 (e.g., using scenario AI agent 322 or 434 and/or other AI agents) generates a story concept 702 and a corresponding transcript 704 (e.g., using voiceover AI agent 342 or AI agents 502, 504, etc.). Scenes 706 may be derived from information in the story concept 702 (e.g., using another AI agent), for example. In shorter videos, the scenes 706 may instead correspond to shots, or there may be only a single shot. In longer videos, the process 700 may include an additional step/layer in which scenes 706 are divided into shots. Other processing steps/layers are also possible.

For each scene of the scenes 706 (or each shot, etc.), a T2I model of models 152 may generate a respective pair of start/end image pairs 710. Thereafter, the media generator 130 may use a tweening technique (e.g., using another one of models 152) to generate the sets 712 of scene frames for the different start/end image pairs 710. In other implementations, media generator 130 may use a different process to generate video, e.g., with more, fewer, and/or different steps/layers than are shown in FIG. 7.

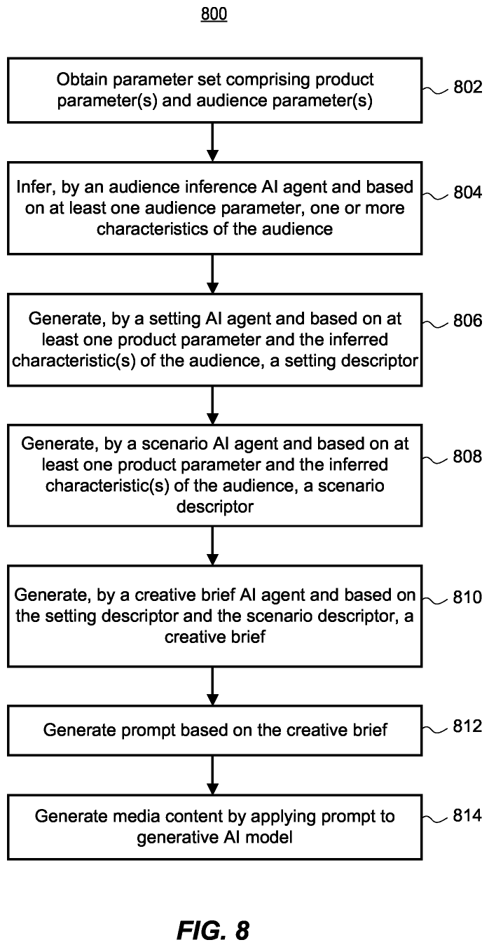

FIG. 8 is a flow diagram of an example method 800 of automatically generating media content (e.g., a video or image(s)) associated with a product and an audience. The method 800 may be implemented by the computing system 102 (e.g., media generator 130, as executed by processor 122) of FIG. 1, for example.

At block 802, a parameter set is obtained (e.g., by data collection module 140). The parameter set includes one or more product parameters (e.g., product parameter(s) 302, or product ID parameter 402 and brand parameter 404) and one or more audience parameters (e.g., audience parameter(s) 304, or location parameter 406 and age parameter 408). Block 802 may include receiving user-entered parameters (e.g., as entered by a user of client device 104 via application 170), and/or automatically retrieved parameters (e.g., from local storage of account data at computing system 102), for example.

At block 804, one or more characteristics of the audience are inferred by an audience inference AI agent (e.g., AI agent 312), based on at least one of the audience parameter(s) obtained at block 802.

At block 806, a setting descriptor is generated by a setting AI agent (e.g., AI agent 320), based on at least one of the product parameter(s) obtained at block 802.

At block 808, a scenario descriptor is generated by a scenario AI agent (e.g., AI agent 322), based on at least one of the product parameter(s) obtained at block 802 and the audience characteristic(s) inferred at block 804.

At block 810, a creative brief is generated by a creative brief AI agent (e.g., AI agent 332), based on the setting descriptor generated at block 806 and the scenario descriptor generated at block 808.

At block 812, a prompt is generated (e.g., by media generator 130), based on the creative brief generated at block 810. For example, the prompt may consist of only the creative brief, or may explicitly instruct a model (e.g., a T2I or T2V model of models 152) to generate the media content based on the creative brief.

At block 814, the media content is generated (e.g., by media generator 130) by applying the prompt generated at block 812 to a generative AI model (e.g., a T2I or T2V model of models 152). In some implementations, block 814 includes using multiple models, e.g., inputting the prompt to a first, T2I model of models 152 that generates starting and ending images/frames for one or more shots or scenes, and then providing the images/frames to a second model of models 152 that generates video frames to fill in the gaps between each starting/ending frame pair.

In other implementations, the method 800 may include more or fewer blocks, and/or certain blocks may occur in an order other than what is shown in FIG. 8. For example, the method 800 may include a first additional block in which feedback is generated (e.g., feedback 610 generated by quality assessment engine 148), where the feedback indicates one or more characteristics of subject matter depicted in the media content that impair quality of the media content (e.g., including applying a quality assessment prompt and the media content to a quality assessment engine), a second additional block in which a revised media generation prompt is generated based on the media generation prompt and the characteristic(s), and a third additional block in which revised media content is generated (e.g., including applying the revised media generation prompt to the generative AI model of block 814). As another example, the method 800 may include an additional block in which a compliance AI agent receives as input the generated video and one or more compliance documents, and output text or a classifier indicating whether the video satisfies criteria, guidelines, regulations, etc., of the compliance document(s).

FIG. 9 is a flow diagram of an example method 900 of improving media content quality. The method 900 may be performed by the media generator 130 of FIG. 1 (e.g., with quality assessment engine 148 performing blocks 904, 906, and 908), for example.

At block 902 of the method 900, media content (e.g., media content 604) is generated, at least in part by applying a media generation prompt to an actor agent (e.g., an agent that uses one of T2I/T2V models 152, or a different agent of FIG. 3 or FIG. 4, etc.) that uses (e.g., locally executes or remotely accesses) a first generative AI model.

At block 904, feedback is generated. The feedback (e.g., feedback 610) indicates one or more characteristics of subject matter depicted in the media content that impair quality of the media content. Block 904 includes applying a quality assessment prompt and the media content to a quality assessment engine (e.g., quality assessment engine 148). The quality assessment engine uses (e.g., locally executes or remotely accesses) a second generative AI model, which may or may not be different from the first generative AI model.

At block 906, a revision prompt is generated based on the media generation prompt and the one or more characteristics.

At block 908, a revised media generation prompt is generated. Block 908 includes applying the revision prompt to a third generative AI model (e.g., as described in connection with stage 612 of FIG. 6), where the third generative AI model may or may not be different from the first and/or second generative AI models. Block 908 may include locally executing or remotely accessing the third generative AI model, for example.

At block 910, revised media content (i.e., a new version of media content 604) is generated. Block 910 includes applying the revised media generation prompt to the actor agent to cause the actor agent to generate the revised media content.

In other implementations, the method 900 may include more or fewer blocks, and/or certain blocks may occur in an order other than what is shown in FIG. 9.

As is apparent from the above description, some of the techniques disclosed herein use artificial intelligence to generate high quality videos for particular products and audiences. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and finetuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the computing system 102 may use one or more of the machine learning models or techniques noted above to perform any one or more of the operations discussed herein in connection with machine learning. For example, the trained AI agents of FIGS. 3, 4, and/or 5 may use one or more such machine learning techniques to make the inferences described herein, and/or to generate the descriptors or classifications described herein.

The following list of examples reflects a variety of the embodiments explicitly contemplated by the present disclosure. Those of ordinary skill in the art will readily appreciate that the examples below are neither limiting of the embodiments disclosed herein, nor exhaustive of all of the embodiments conceivable from the disclosure above, but are instead meant to be exemplary in nature.

Example 1. A method of automatically generating media content associated with a product and an audience, the method comprising: obtaining, by one or more processors, a parameter set comprising (i) one or more product parameters associated with the product and (ii) one or more audience parameters associated with the audience; generating, by the one or more processors, a creative brief for the media content, at least in part by processing the parameter set using a set of trained artificial intelligence (AI) agents, wherein processing the parameter set using the set of trained AI agents includes: inferring, by an audience inference AI agent and based on at least one of the one or more audience parameters, one or more characteristics of the audience; generating, by a setting AI agent and based on (i) at least one of the one or more product parameters and (ii) the inferred one or more characteristics of the audience, a setting descriptor; generating, by a scenario AI agent and based on (i) at least one of the one or more product parameters and (ii) the inferred one or more characteristics of the audience, a scenario descriptor; and generating, by a creative brief AI agent and based on the setting descriptor and the scenario descriptor, the creative brief; generating, by the one or more processors, a prompt based on the creative brief; and generating, by the one or more processors, the media content at least in part by applying the prompt to a generative AI model.

Example 2. The method of example 1, wherein: processing the parameter set using the set of trained AI agents further includes generating, by a character AI agent and based on the inferred one or more characteristics of the audience, a character descriptor; and generating the creative brief is further based on the character descriptor.

Example 3. The method of example 1 or 2, wherein generating the setting descriptor includes: generating, by a product descriptor AI agent and based on at least one of the one or more product parameters, a product descriptor; and generating the setting descriptor based on (i) the product descriptor and (ii) the inferred one or more characteristics of the audience.

Example 4. The method of any one of examples 1-3, wherein: processing the parameter set using the set of trained AI agents further includes generating, by a technique AI agent and based on (i) the inferred one or more characteristics of the audience and (ii) the setting descriptor, a technique descriptor that specifies one or more of an establishment shot, a lighting technique, color grading, or shot composition; and generating the creative brief is further based on the technique descriptor.

Example 5. The method of any one of examples 1-4, wherein: the audience inference AI agent includes an interest inference AI agent and a demographic inference AI agent; the one or more audience parameters include a location parameter and an age parameter; inferring the one or more characteristics of the audience includes: inferring, by the interest inference AI agent and based on (i) the location parameter and (ii) the age parameter, one or more interests of the audience; and inferring, by the demographic inference AI agent and based on the location parameter, one or more demographic characteristics of the audience; generating the setting descriptor is based on (i) at least one of the one or more product parameters and (ii) the inferred one or more interests of the audience; and generating the scenario descriptor is based on (i) at least one of the one or more product parameters, (ii) the inferred one or more interests of the audience, and (ii) the inferred one or more demographic characteristics of the audience.

Example 6. The method of any one of examples 1-5, wherein: the one or more audience parameters include an age parameter; the method further comprises mapping, by the one or more processors, the age parameter to a tone parameter that specifies a tone of the media content; and generating the creative brief is further based on the tone parameter.

Example 7. The method of any one of examples 1-6, further comprising: generating, by the one or more processors implementing a voiceover AI agent and based on (i) at least one of the one or more audience parameters and (ii) the inferred one or more characteristics of the audience, one or both of (i) a voiceover script, and (ii) a voiceover type, to accompany the media content.

Example 8. The method of any one of examples 1-7, further comprising: determining, by the one or more processors implementing a music AI agent and based on (i) at least one of the one or more audience parameters and (ii) the inferred one or more characteristics of the audience, a type of music to accompany the media content.

Example 9. The method of example 8, wherein: the one or more audience parameters include an age parameter; the method further comprises mapping, by the one or more processors, the age parameter to a tone parameter that specifies a tone of the media content; and determining the type of music is further based on the tone parameter.

Example 10. The method of any one of examples 1-9, further comprising: monitoring, by the one or more processors, performance associated with the generated media content; and one or both of: modifying, based on the monitored performance, a respective prompt to each of one or more AI agents in the set of trained AI agents; and retraining, based on the monitored performance, one or more AI agents of the set of trained AI agents.

Example 11. The method of any one of examples 1-10, wherein: processing the parameter set using the set of trained AI agents includes selecting, by an asset selection AI agent and based on at least one of the one or more audience parameters, one or more digital assets; and generating the creative brief is further based on the one or more digital assets.

Example 12. The method of any one of examples 1-11, wherein the set of trained AI agents is configured as a microservices architecture.

Example 13. The method of any one of examples 1-12, wherein the prompt is a media generation prompt, the generative AI model is a first generative AI model, and the method further comprises: generating, by the one or more processors, feedback indicating one or more characteristics of subject matter depicted in the media content that impair quality of the media content, at least in part by applying a quality assessment prompt and the media content to a quality assessment engine, wherein the quality assessment engine uses a second generative AI model; generating, by the one or more processors, a revised media generation prompt based on the media generation prompt and the one or more characteristics; and generating, by the one or more processors, revised media content, at least in part by applying the revised media generation prompt to the first generative AI model.

Example 14. The method of example 13, wherein generating the revised media generation prompt includes: generating a revision prompt based on the media generation prompt and the one or more characteristics; and generating the revised media generation prompt at least in part by applying the revision prompt to a third generative AI model.

Example 15. The method of example 14, wherein: the feedback (i) includes a text descriptor of the one or more characteristics and (ii) indicates a region of the media content that is associated with at least one of the one or more characteristics; generating the revision prompt is based on the media generation prompt and the text descriptor; and generating the revised media generation prompt includes applying at least the region of the media content to the third generative AI model.

Example 16. The method of any one of examples 13-15, wherein the quality assessment prompt includes one or more keywords that activate learned states of the second generative AI model associated with high-quality media content.

Example 17. The method of any one of examples 13-16, further comprising: generating, by the one or more processors and based on feedback generated by the quality assessment engine over a plurality of earlier iterations, a plurality of concise learnings for improving media content quality; and storing, by the one or more processors, the plurality of concise learnings in a long-term context database, wherein the media generation prompt includes or links to at least a subset of the plurality of concise learnings.

Example 18. The method of any one of examples 1-17, wherein generating the creative brief further includes increasing media content diversification by applying one or more encoded source vectors to one or more AI agents of the set of trained AI agents, and wherein each of the one or more encoded source vectors includes a plurality of elements corresponding to a plurality of respective media content aspects.

Example 19. The method of example 18, wherein each of the plurality of respective media content aspects corresponds to a different one of the set of trained AI agents.

Example 20. A system comprising: one or more processors; and one or more memories storing instructions that, when executed by the one or more processors, cause the one or more processors to perform the method of any one of examples 1-19.

Example 21. One or more non-transitory, computer-readable media storing instructions that, when executed by one or more processors, cause the one or more processors to perform the method of any one of examples 1-19.

Example 22. A method of improving media content quality, the method comprising: generating, by one or more processors, media content at least in part by applying a media generation prompt to an actor agent that uses a first generative artificial intelligent (AI) model; generating, by the one or more processors, feedback indicating one or more characteristics of subject matter depicted in the media content that impair quality of the media content, at least in part by applying a quality assessment prompt and the media content to a quality assessment engine, wherein the quality assessment engine uses a second generative AI model; generating, by the one or more processors, a revision prompt based on the media generation prompt and the one or more characteristics; generating, by the one or more processors, a revised media generation prompt, at least in part by applying the revision prompt to a third generative AI model; and generating, by the one or more processors, revised media content, at least in part by applying the revised media generation prompt to the actor agent.

Example 23. The method of example 22, wherein: the quality assessment prompt instructs the second generative AI model to indicate whether the media content is of acceptable quality; and generating the revision prompt is responsive to the second generative AI model indicating that the media content is not of acceptable quality.

Example 24. The method of example 22 or 23, wherein the quality assessment prompt includes one or more keywords that activate learned states of the second generative AI model associated with high-quality media content.

Example 25. The method of any one of examples 22-24, wherein: the feedback includes a text descriptor of the one or more characteristics; and generating the revision prompt is based on the media generation prompt and the text descriptor of the one or more characteristics.

Example 26. The method of any one of examples 22-25, wherein: the feedback indicates a region of the media content that is associated with at least one of the one or more characteristics; and generating the revised media generation prompt includes applying at least the region of the media content to the third generative AI model.

Example 27. The method of any one of examples 22-26, further comprising: generating, by the one or more processors and based on feedback generated by the quality assessment engine over a plurality of earlier iterations, a plurality of concise learnings for improving media content quality; and storing, by the one or more processors, the plurality of concise learnings in a long-term context database, wherein the media generation prompt includes or links to at least a subset of the plurality of concise learnings.

Example 28. The method of example 27, wherein generating the plurality of concise learnings includes using a fourth generative AI model to generate the plurality of concise learnings.

Example 29. The method of example 28, wherein the second generative AI model is the fourth generative AI model.

Example 30. The method of any one of examples 22-29, wherein the one or more characteristics are characteristics that impair cinematic quality of the media content.

Example 31. The method of any one of examples 22-30, wherein: the feedback includes (i) detailed reasoning on why the one or more characteristics impair the quality of the media content and (ii) a summary of at least a subset of the one or more characteristics; and generating the revision prompt is based on the media generation prompt, the detailed reasoning, and the summary.

Example 32. The method of any one of examples 22-31, wherein the media generation prompt indicates one or more previous media generation prompt revisions corresponding to one or more previous iterations of revising the media content.

Example 33. The method of any one of examples 22-32, wherein the media content includes one or both of image content and video content.

Example 34. The method of any one of examples 22-33, wherein generating the feedback includes embedding metadata indicative of at least a portion of the feedback in a media data file corresponding to the media content.

Example 35. A system comprising: one or more processors; and one or more memories storing instructions that, when executed by the one or more processors, cause the one or more processors to perform the method of any one of examples 22-34.

Example 36. One or more non-transitory, computer-readable media storing instructions that, when executed by one or more processors, cause the one or more processors to perform the method of any one of examples 22-34.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims.

The following additional considerations apply to the foregoing discussion and the appended claims. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first set of one or more processors (e.g., in a first computing device) generates X and a distinct, second set of one or more processors (e.g., in a different, second computing device) independently generates Y; (2) implementations in which all processors in the set of one or more processors (e.g., all in the same device, or distributed among multiple devices) contribute to the generation of both X and Y; and (3) other variations.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method of automatically generating media content associated with a product and an audience, the method comprising:
obtaining, by one or more processors, a parameter set comprising (i) one or more product parameters associated with the product and (ii) one or more audience parameters associated with the audience;
generating, by the one or more processors, a creative brief for the media content, at least in part by processing the parameter set using a set of trained artificial intelligence (AI) agents, wherein processing the parameter set using the set of trained AI agents includes:
inferring, by an audience inference AI agent and based on at least one of the one or more audience parameters, one or more characteristics of the audience;
generating, by a setting AI agent and based on (i) at least one of the one or more product parameters and (ii) the inferred one or more characteristics of the audience, a setting descriptor;
generating, by a scenario AI agent and based on (i) at least one of the one or more product parameters and (ii) the inferred one or more characteristics of the audience, a scenario descriptor; and
generating, by a creative brief AI agent and based on the setting descriptor and the scenario descriptor, the creative brief;
generating, by the one or more processors, a prompt based on the creative brief; and
generating, by the one or more processors, the media content at least in part by applying the prompt to a generative AI model.

2. The method of claim 1, wherein:
processing the parameter set using the set of trained AI agents further includes generating, by a character AI agent and based on the inferred one or more characteristics of the audience, a character descriptor; and
generating the creative brief is further based on the character descriptor.

3. The method of claim 1, wherein generating the setting descriptor includes:
generating, by a product descriptor AI agent and based on at least one of the one or more product parameters, a product descriptor; and
generating the setting descriptor based on (i) the product descriptor and (ii) the inferred one or more characteristics of the audience.

4. The method of claim 1, wherein:
processing the parameter set using the set of trained AI agents further includes generating, by a technique AI agent and based on (i) the inferred one or more characteristics of the audience and (ii) the setting descriptor, a technique descriptor that specifies one or more of an establishment shot, a lighting technique, color grading, or shot composition; and
generating the creative brief is further based on the technique descriptor.

5. The method of claim 1, wherein:
the audience inference AI agent includes an interest inference AI agent and a demographic inference AI agent;
the one or more audience parameters include a location parameter and an age parameter;
inferring the one or more characteristics of the audience includes:
inferring, by the interest inference AI agent and based on (i) the location parameter and (ii) the age parameter, one or more interests of the audience; and
inferring, by the demographic inference AI agent and based on the location parameter, one or more demographic characteristics of the audience;
generating the setting descriptor is based on (i) at least one of the one or more product parameters and (ii) the inferred one or more interests of the audience; and
generating the scenario descriptor is based on (i) at least one of the one or more product parameters, (ii) the inferred one or more interests of the audience, and (ii) the inferred one or more demographic characteristics of the audience.

6. The method of claim 1, wherein:
the one or more audience parameters include an age parameter;
the method further comprises mapping, by the one or more processors, the age parameter to a tone parameter that specifies a tone of the media content; and
generating the creative brief is further based on the tone parameter.

7. The method of claim 1, further comprising:
generating, by the one or more processors implementing a voiceover AI agent and based on (i) at least one of the one or more audience parameters and (ii) the inferred one or more characteristics of the audience, one or both of (i) a voiceover script, and (ii) a voiceover type, to accompany the media content.

8. The method of claim 1, further comprising:
determining, by the one or more processors implementing a music AI agent and based on (i) at least one of the one or more audience parameters and (ii) the inferred one or more characteristics of the audience, a type of music to accompany the media content.

9. The method of claim 1, further comprising:
monitoring, by the one or more processors, performance associated with the generated media content; and
one or both of:
modifying, based on the monitored performance, a respective prompt to each of one or more AI agents in the set of trained AI agents; and
retraining, based on the monitored performance, one or more AI agents of the set of trained AI agents.

10. The method of claim 1, wherein:
processing the parameter set using the set of trained AI agents includes selecting, by an asset selection AI agent and based on at least one of the one or more audience parameters, one or more digital assets; and
generating the creative brief is further based on the one or more digital assets.

11. The method of claim 1, wherein the set of trained AI agents is configured as a microservices architecture.

12. The method of claim 1, wherein the prompt is a media generation prompt, the generative AI model is a first generative AI model, and the method further comprises:
generating, by the one or more processors, feedback indicating one or more characteristics of subject matter depicted in the media content that impair quality of the media content, at least in part by applying a quality assessment prompt and the media content to a quality assessment engine, wherein the quality assessment engine uses a second generative AI model;
generating, by the one or more processors, a revised media generation prompt based on the media generation prompt and the one or more characteristics; and
generating, by the one or more processors, revised media content, at least in part by applying the revised media generation prompt to the first generative AI model.

13. The method of claim 12, wherein generating the revised media generation prompt includes:
generating a revision prompt based on the media generation prompt and the one or more characteristics; and
generating the revised media generation prompt at least in part by applying the revision prompt to a third generative AI model.

14. The method of claim 13, wherein:
the feedback (i) includes a text descriptor of the one or more characteristics and (ii) indicates a region of the media content that is associated with at least one of the one or more characteristics;
generating the revision prompt is based on the media generation prompt and the text descriptor; and
generating the revised media generation prompt includes applying at least the region of the media content to the third generative AI model.

15. The method of claim 12, wherein the quality assessment prompt includes one or more keywords that activate learned states of the second generative AI model associated with high-quality media content.

16. The method of claim 12, further comprising:
generating, by the one or more processors and based on feedback generated by the quality assessment engine over a plurality of earlier iterations, a plurality of concise learnings for improving media content quality; and
storing, by the one or more processors, the plurality of concise learnings in a long-term context database, wherein the media generation prompt includes or links to at least a subset of the plurality of concise learnings.

17. The method of claim 1, wherein generating the creative brief further includes increasing media content diversification by applying one or more encoded source vectors to one or more AI agents of the set of trained AI agents, and wherein each of the one or more encoded source vectors includes a plurality of elements corresponding to a plurality of respective media content aspects.

18. A system comprising:
one or more processors; and
one or more memories storing instructions that, when executed by the one or more processors, cause the one or more processors to perform operations comprising:
obtaining a parameter set comprising (i) one or more product parameters associated with a product and (ii) one or more audience parameters associated with an audience;
generating a creative brief for media content associated with the product and the audience, at least in part by processing the parameter set using a set of trained artificial intelligence (AI) agents, wherein processing the parameter set using the set of trained AI agents includes:
inferring, by an audience inference AI agent and based on at least one of the one or more audience parameters, one or more characteristics of the audience;
generating, by a setting AI agent and based on (i) at least one of the one or more product parameters and (ii) the inferred one or more characteristics of the audience, a setting descriptor;
generating, by a scenario AI agent and based on (i) at least one of the one or more product parameters and (ii) the inferred one or more characteristics of the audience, a scenario descriptor; and
generating, by a creative brief AI agent and based on the setting descriptor and the scenario descriptor, the creative brief;
generating a prompt based on the creative brief; and
generating the media content at least in part by applying the prompt to a generative AI model.

19. A method of improving media content quality, the method comprising:
generating, by one or more processors, media content at least in part by applying a media generation prompt to an actor agent that uses a first generative artificial intelligent (AI) model;
generating, by the one or more processors, feedback indicating one or more characteristics of subject matter depicted in the media content that impair quality of the media content, at least in part by applying a quality assessment prompt and the media content to a quality assessment engine, wherein the quality assessment engine uses a second generative AI model;
generating, by the one or more processors, a revision prompt based on the media generation prompt and the one or more characteristics;
generating, by the one or more processors, a revised media generation prompt, at least in part by applying the revision prompt to a third generative AI model; and
generating, by the one or more processors, revised media content, at least in part by applying the revised media generation prompt to the actor agent.

20. The method of claim 19, wherein:
the quality assessment prompt instructs the second generative AI model to indicate whether the media content is of acceptable quality;
generating the revision prompt is responsive to the second generative AI model indicating that the media content is not of acceptable quality; and
the quality assessment prompt includes one or more keywords that activate learned states of the second generative AI model associated with high-quality media content.
